(19) United States
(12) Patent Application Publication
(10) Pub. No.: US 2024/0255718 A1
(43) Pub. Date: Aug. 1, 2024

(54) OPTICAL FIBER RIBBON CONFIGURED TO MAINTAIN ORIENTATION OF POLARIZATION-MAINTAINING AND MULTICORE OPTICAL FIBERS

(71) Applicant: CORNING RESEARCH & DEVELOPMENT CORPORATION, Corning, NY (US)

(72) Inventors: Scott Robertson Bickham, Corning, NY (US); Julie Ann Chalk, Hickory, NC (US); David Wesley Chiasson, Edmonton (CA); Stephan Lvovich Logunov, Corning, NY (US)

(21) Appl. No.: 18/630,250

(22) Filed: Apr. 9, 2024

Related U.S. Application Data
(63) Continuation of application No. PCT/US2022/047713, filed on Oct. 25, 2022.
(60) Provisional application No. 63/274,975, filed on Nov. 3, 2021.

(51) Int. Cl. G02B 6/44; G02B 6/02; G02B 6/024

(52) U.S. Cl. CPC G02B 6/4434; G02B 6/02042; G02B 6/024; G02B 6/448

(57) ABSTRACT

Provided are embodiments of an optical fiber ribbon. The optical fiber ribbon includes a plurality of optical fibers arranged adjacently. The plurality of optical fibers are joined intermittently or continuously along their length. Each optical fiber of the plurality of optical fibers has at least one core having a first refractive index, a cladding region having a second refractive index different from the first refractive index, and a third region disposed within the cladding region. The third region has a third refractive index different from the first refractive index and from the second refractive index. The third region of each optical fiber includes a centroid having a true position according to ASME Y14.5-2009 relative to an adjacent optical fiber that is within a diametrical tolerance of 50 μm. Embodiments of a method and a system for preparing such and optical fiber ribbon are also provided.

### PRIORITY APPLICATION

This application is a continuation of International Patent Application No. PCT/US2022/047713, filed Oct. 25, 2022, which claims the benefit of priority of U.S. Provisional Application No. 63/274,975, filed on Nov. 3, 2021, the content of which is relied upon and incorporated herein by reference in its entirety.

### BACKGROUND OF THE DISCLOSURE

The present disclosure generally relates to optical fiber ribbons and in particular to optical fiber ribbons in which the optical fibers are maintained in a desired orientation.

Optical fibers are provided in multiple different designs to serve specific functions within an optical system. In general, optical fibers comprise a waveguide that includes a core to carry optical signals and a cladding surrounding the core. However, the structure and number of cores in an optical fiber can vary, and the components contained in the cladding can impart various different properties to the optical fiber. For optical fibers for certain specialized applications, the cladding may include structures which break the cylindrical symmetry of the waveguide and introduce a systematic linear birefringence. Linearly-polarized light launched into such a fiber will maintain its polarization state with minimal coupling into the orthogonal polarization state. In some applications, it is desirable to align these optical fibers with a particular orientation with respect to other system components. For example, these fibers may be used in telecommunications applications to couple linearly-polarized light from a laser into a modulator. Thus, in certain circumstances, it may be important to maintain a proper orientation of the optical fiber during installation and use.

### SUMMARY OF THE DISCLOSURE

In one aspect, embodiments of the present disclosure relate to an optical fiber ribbon. In one or more embodiments, the optical fiber ribbon includes a plurality of optical fibers arranged adjacently. In one or more embodiments, the plurality of optical fibers are joined intermittently or continuously along their length. Further, in one or more embodiments, each optical fiber of the plurality of optical fibers has at least one core having a first refractive index, a cladding region having a second refractive index different from the first refractive index, and a third region disposed within the cladding region. In such embodiments, the third region has a third refractive index that may be different from the first refractive index and from the second refractive index. In one or more embodiments, the third region of each optical fiber includes a centroid having a true position according to ASME Y14.5-2009 relative to an adjacent optical fiber that is within a diametrical tolerance of 50 μm.

In another aspect, embodiments of the present disclosure relate to a method of joining a plurality of optical fibers. In one or more embodiments of the method, an orientation of each optical fiber of the plurality of optical fibers is determined. Each optical fiber may include at least one core, a cladding surrounding the at least one core, and a third region disposed within the cladding. In one or more embodiments of the method, the orientation of each optical fiber of the plurality of optical fibers is independently adjusted so that the third region of each optical fiber has substantially a same orientation as the third region of each other of the plurality of optical fibers. Further, in one or more embodiments of the method, the plurality of optical fibers are intermittently or continuously bonded to each other while the third regions have the same orientation.

In still another aspect, embodiments of the present disclosure relate to a system for joining a plurality of optical fibers. In one or more embodiments, the system includes an imaging system configured to capture a side view of each optical fiber of the plurality of optical fibers. Further, in one or more embodiments, the system includes an applicator configured to deposit bonding material continuously around or intermittently between adjacent optical fibers of the plurality of optical fibers. Additionally, in one or more embodiments, the system includes a control system configured to determine an orientation of each optical fiber of the plurality of optical fibers based on a characteristic width of a component of each optical from the side view of each optical fiber. In one or more such embodiments, the control system is further configured to independently adjust the orientation of each optical fiber based on the determined orientation.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding and are incorporated in and constitute a part of this specification. The drawings illustrate one or more embodiments, and together with the description serve to explain principles and operation of the various embodiments.

### BRIEF DESCRIPTION OF THE DRAWINGS

FIGS. 1A-1C depict various embodiments of a polarization-maintaining optical fibers, according to exemplary embodiments;

FIG. 2 depicts a polarization-maintaining optical fiber with various regions identifiable from a side-imaging view labeled, according to an exemplary embodiment;

FIG. 3 depicts various geometric parameters of the polarization-maintaining optical fiber of FIG. 2, according to an exemplary embodiment;

FIGS. 4A-4C depict the polarization-maintaining optical fiber of FIG. 2 at various angular orientations which produces different characteristic widths of the cladding and core regions, according to exemplary embodiments;

FIG. 5 depicts the angular dependence of the characteristic widths of the core and cladding regions, according to an exemplary embodiment;

FIG. 6 is a plot of the characteristic widths of the core and cladding regions as a function of rotational error, according to an exemplary embodiment;

FIG. 7 depicts an example of an optical system incorporating polarization-maintaining optical fibers, according to an example embodiment;

FIGS. 8A and 8B depict endfaces of fiber array units with the polarization-maintaining optical fibers arranged in two different orientations, according to example embodiments;

FIGS. 9A and 9B depict embodiments of 2×2 multicore optical fibers, according to example embodiments;

FIG. 10 depicts a refractive index profile with a rectangular trench for a core region of a multicore optical fiber, according to an example embodiment;

FIG. 11 depicts a refractive index profile with a triangular trench for a core region of a multicore optical fiber, according to an example embodiment;

FIG. 12 depicts an embodiment of a multicore optical fiber having four cores arranged linearly across the optical fiber in a 1×4 array, according to an example embodiment;

FIG. 13 depicts geometric parameters of the 1×4 multicore optical fiber, according to an example embodiment;

FIGS. 14A and 14B depict characteristic widths of the core and cladding regions based on angular orientation of the marker of the 1×4 multicore optical fiber relative to vertical, according to example embodiments;

FIG. 15 is a plot of the characteristic widths of the core and cladding of the 1×4 multicore optical fiber as a function of rotational error, according to an example embodiment;

FIGS. 16A and 16B depict characteristic widths of the core and cladding regions based on angular orientation of the marker of the 1×4 multicore optical fiber relative to horizontal, according to example embodiments;

FIG. 17 depicts geometric parameters of the 1×4 multicore optical fiber for determining angular orientation of the marker relative to horizontal, according to an example embodiment;

FIG. 18 is a plot of the characteristic widths of the core and cladding of the 1×4 multicore optical fiber as a function of rotational error, according to an example embodiment;

FIGS. 19A-19D depict characteristic widths of the core and cladding regions of a multicore optical fiber having a 2×2 array of core regions based on angular orientation, according to example embodiments;

FIG. 20 depicts geometric parameters of the 2×2 multicore optical fiber for determining the angular orientation, according to an example embodiment;

FIG. 21 depicts a plot of the characteristic width of the cladding as a function of rotational error, according to an example embodiment;

FIGS. 22-24 depict various embodiments of an optical fiber ribbon having at least one intermittently bonded component, according to example embodiments;

FIG. 25 depicts an embodiment of an optical fiber ribbon having continuously bonded subunits and a continuous matrix layer, according to an example embodiment;

FIGS. 26 and 27 depict embodiments of systems for preparing subunits or ribbons with oriented polarization-maintaining or multicore optical fibers, according to example embodiments;

FIGS. 28A-28B, 29A-29B, 30A-30B, 31A-31C, and 32A-32C depict various examples of intermittent bonding between subunits that is applied in such as way as to avoid overlap of intermittent bonds along the length of the optical fiber ribbon; and

FIG. 33 depicts an example of geometric dimensioning and tolerancing used to determine proper orientation of one optical fiber relative to another, according to an exemplary embodiment.

### DETAILED DESCRIPTION

Reference will now be made in detail to the present preferred embodiments, examples of which are illustrated in the accompanying drawings. The following detailed description represents embodiments that are intended to provide an overview or framework for understanding the nature and character of the claims. The accompanied drawings are included to provide a further understanding of the claims and constitute a part of the specification. The drawings illustrate various embodiments, and together with the descriptions serve to explain the principles and operations of these embodiments as claimed.

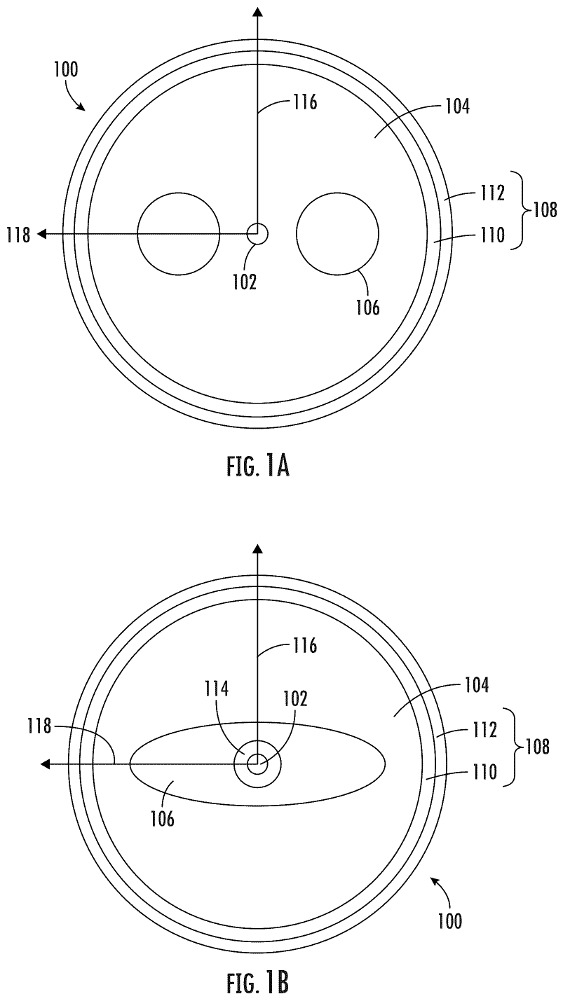

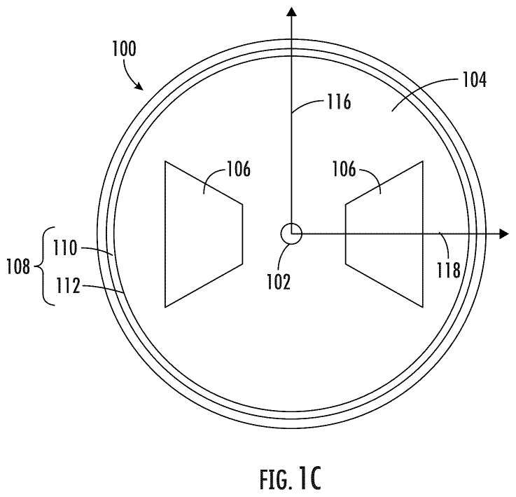

FIGS. 1A-1C depict cross-sections of example embodiments of polarization-maintaining (PM) optical fibers 100. The optical fibers 100 have circular cross-sections that extend along a longitudinal axis of a length of the optical fibers 100. Each of the example PM optical fibers 100 includes a core 102 surrounded by a cladding 104. In embodiments, the core 102 has a circular cross-section that extends along and is situated on the longitudinal axis of the optical fiber 100. The cores 102 of the PM optical fibers 100 are single mode cores that are single mode above a specified wavelength, such as 980 nm, 1060 nm, or 1260 nm. The cladding 104 surrounds the core 102 along the length of the optical fiber 100. Disposed within the cladding 104 are one or more stress members 106. In one or more embodiments, the cladding 104 is surrounded by at least one coating layer 108, such as a primary coating layer 110 and a secondary coating layer 112. The at least one coating layer 108 provides mechanical protection for the PM optical fiber 100. In embodiments, the primary coating layer 110 is a soft, curable resin that provides cushioning for the core 102 and cladding 104, and the secondary coating layer 110 is a hard, curable resin that provides protection against external stresses.

As can be seen in FIG. 1A, the PM optical fiber 100 includes two circular stress-modifying regions or members 106 diametrically arranged around the core 102 and that extend along the length of the PM optical fiber 100. As can be seen in FIG. 1B, the PM optical fiber 100 includes one elliptical stress member 106 that surrounds the core 102 and that extends along the length of the PM optical fiber 100. Further, from FIG. 1B, it can be seen that an inner cladding 114 is disposed between the core 102 and the elliptical stress member 102. As can be seen in FIG. 1C, the PM optical fiber 100 includes two trapezoidal stress members 106 diametrically arranged around the core 102 and that extend along the length of the PM optical fiber 100.

In one or more embodiments having silica-based cladding 104, the stress modifying regions or members 106 may comprise boron-doped silica that break the cylindrical symmetry of the fiber and create fast and slow axes of propagation that are orthogonal to and parallel to the plane of the stress members 106, respectively. FIGS. 1A-1C depict the fast axis 116 and the slow axis 118 for each PM optical fiber 100. The high concentration of boron in the stress members 106 decreases the refractive index of the silica cladding 104, which optically squeezes the polarization component in the plane of the stress members 106 as compared to the perpendicular plane between the stress members 106.

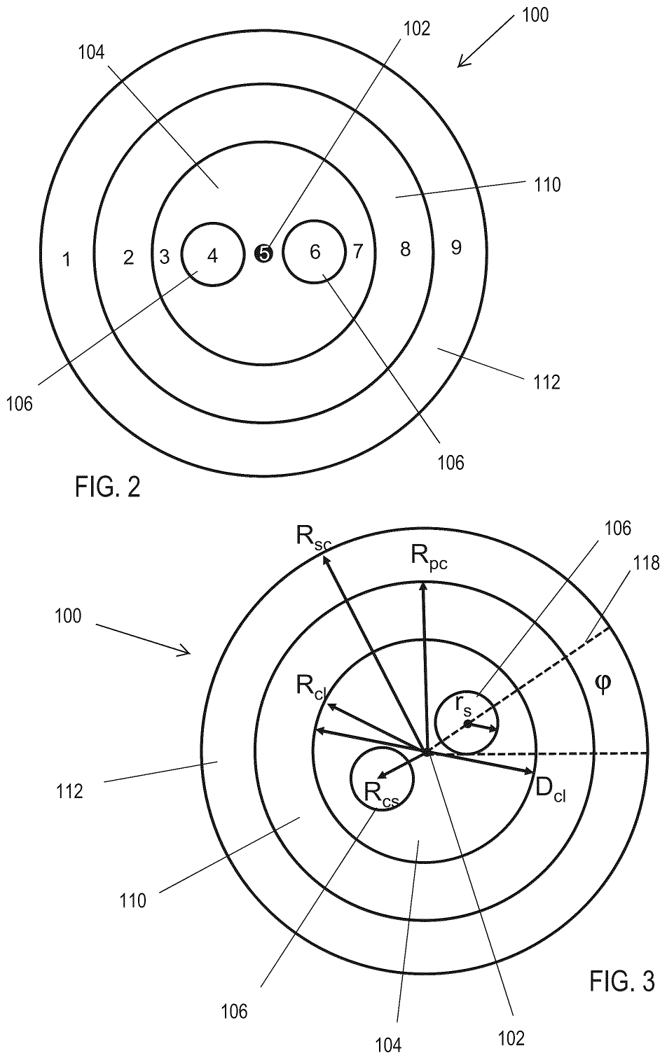

With reference to the PM optical fiber 100 shown in FIG. 1A, the refractive index at various positions of the PM optical fiber 100 will vary across the diameter. FIG. 2 depicts a PM optical fiber 100 with the various regions labeled as 1-9. In particular, regions 1 and 9 refer to the outer, secondary coating 112. Regions 2 and 8 refer to the inner, primary coating 110. Regions 3 and 7 refer to the cladding 104, in particular the cladding 104 outside of the stress regions 106 and the core 102. Regions 4 and 6 refer to the stress members 106, and region 5 refers to the core 102. The refractive index in each of regions 1 and 9, regions 2 and 8, regions 3 and 7, regions 4 and 6, and region 5 is different from the refractive index in the other regions.

The difference in refractive index between the regions of the PM optical fiber 100 can be described using a relative refractive index based on radial position within the PM optical fiber 100 described as follows. “Radial position” and “radial distance” when used in reference to the radial coordinate “R” refer to radial position relative to the centerline (R=0) of the PM optical fiber 100. Further, the “relative refractive index” or “relative refractive index percent” as used herein with respect to the regions of PM optical fiber 100 is defined according to equation (1):

$$Δ \% = 100 \frac{{n}^{2} ( R ) - {n}_{c}^{2}}{2 {n}^{2} ( R )} \qquad ( 1 )$$

where n(R) is the refractive index at the radial distance R from the waveguide's centerline (corresponding to R=0) and n_{c} is the refractive index of the cladding 104. The refractive indices are measured at a wavelength of 1550 nm, unless otherwise specified. In some embodiments, the cladding 104 comprises undoped silica glass and n_{c} is equal to 1.444. In some embodiments, the cladding 104 comprises silica doped with an up-dopant (e.g. chlorine), and n_{c} is greater than 1.444. In some embodiments, the cladding 104 comprises silica doped with a down-dopant (e.g. fluorine), and n_{c} is less than 1.444.

As used herein, the relative refractive index is represented by Δₙ (or “delta”) or Δₙ% (or “delta %”) and its values are given in units of “%” or “% Δ”, unless otherwise specified. Relative refractive index may also be expressed as Δₙ(R) or Δₙ(R) %. When the refractive index of a region is less than the reference index n_{c} of the cladding 104, the relative refractive index is negative and can be referred to as a depressed region. When the refractive index of a region is greater than the reference index n_{c} of the cladding 104, the relative refractive index is positive and the region can be said to be raised or a positive relative refractive index.

As used herein, radial position R₅ and relative refractive index Δ₅ or Δ₅(R) refer to the core region 102 of the PM optical fiber 100, radial position R₄ and relative refractive index Δ₄ or Δ₄(R) refer to the stress members 106, and radial position R₃ and relative refractive index Δ₃ or Δ₃(R) refer to the cladding 104. Radial positions R₂ and R₁ refer to inner and outer coatings 110, 112, respectively, that circumferentially surround the cladding 104.

In an example embodiment using the cladding 104 as the reference region (i.e., Δ₃=0), the core 102 in region 5 may have a relative refractive index Δ₅ of about 0.5%, the stress members 106 in region 4 may be boron-doped and have a relative refractive index Δ₄ of about −0.8%, the primary coating 110 in region 2 may have a relative refractive index Δ₂ of about 2.9%, and the secondary coating 112 in region 1 may have a relative refractive index Δ₁ of about 5.1%. The relative refractive indices were given for regions 1-5 as shown in FIG. 2, but as will be appreciated from FIG. 2, the relative refractive indices for regions 6-9 will correspond to the relative refractive indices for the corresponding regions 1-4. Further, these relative refractive indices are merely illustrative, and other embodiments of a PM optical fiber 100 may have different relative refractive indices for regions 1-9.

The changes in refractive indices between regions 1-9 as demonstrated by the relative refractive indices allows the respective regions 1-9 to be differentiated when imaged from along the length of the optical fiber 100. Further, the width of each region when imaged from the side of the PM optical fiber 100 will vary based on the angular orientation of the PM optical fiber 100. FIG. 3 depicts a PM optical fiber 100 with various geometric parameters shown, which as will be discussed in relation to the figures that follow, can be used to calculate the angular orientation of the PM optical fiber 100. In particular, the PM optical fiber 100 includes a radius R_{sc} which is the radius of the secondary coating 112. R_{pc} is the radius of the primary coating 110. R_{cl} is the radius of the cladding 104, and D_{cl} is the diameter of the cladding 104. R_{cs} is the radius to the center of each stress region 106, and rₛ is the radius of each stress region 106. The slow axis 118 of the PM optical fiber 100 is arranged at an angle φ relative to horizontal or 0°.

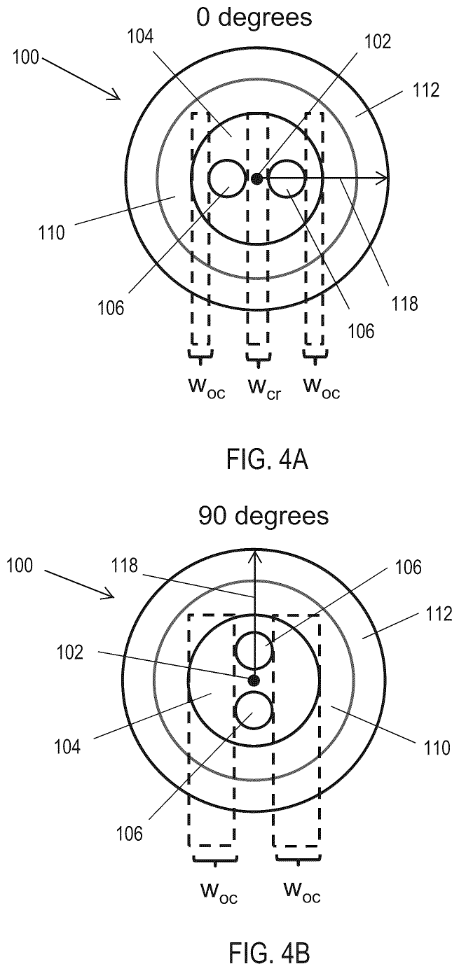

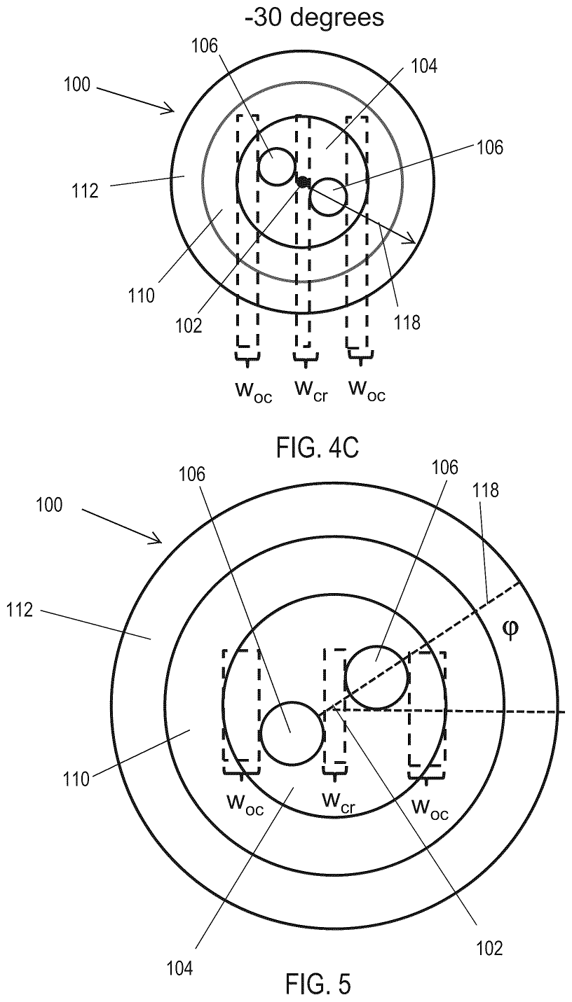

Additionally, as shown in FIGS. 4A-4C, the width of the cladding 104 (in particular regions 3 and 7 outside the core 102 and stress members 106) varies based on the angular position of the PM optical fiber 100. As shown in FIG. 4A, the slow axis of the PM optical fiber 100 is arranged horizontally at the 0° position. In this position, the cladding 104 has a minimum characteristic width w_{oc}, and the core 102 has a maximum characteristic width w_{cr}. As shown in FIG. 4B, the characteristic width w_{oc} of the cladding 104 increases to a maximum when the slow axis of the PM optical fiber 100 is arranged vertically in a 90° position, and the core 102 is no longer visible as the core 102 and stress members 106 are vertically aligned. FIG. 4C depicts the PM optical fiber 100 arranged intermediate of the horizontal and vertical positions in which the characteristic widths w_{cr}, w_{oc} of the core 102 and cladding 104 are between their minimums and maximums. In FIG. 4C, the slow axis of the PM optical fiber 100 is arranged at an angular orientation of −30°.

FIG. 5 depicts a PM optical fiber 100 with the slow axis 118 arranged at an angle φ relative to horizontal such that the cladding 104 has characteristic widths w_{oc} and the core 102 has a characteristic width w_{cr}. The characteristics widths w_{oc} and w_{cr} can be determined according to the following equations 2 and 3:

$${w}_{oc} = {R}_{cl} - {r}_{s} - {R}_{cs} cos ( φ ) \qquad ( 2 )$$

$${w}_{cr} = 2 {R}_{cs} cos ( φ ) - 2 {r}_{s} \qquad ( 3 )$$

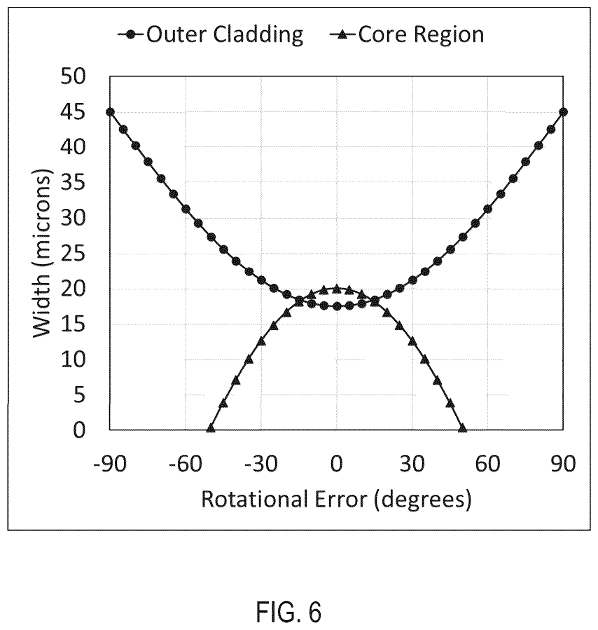

Using these equations, the characteristic widths w_{oc} and w_{cr} of the cladding 104 and core 102 were plotted in FIG. 6 as a function of angular orientation. In particular, the angular orientation φ is referred to as “rotational error” based on a desired orientation of the slow axis of the PM optical fiber 100 as being at the horizontal, 0° position. For the example embodiment plotted in FIG. 6, the radius R_{cl} of the cladding 104 is 62.5 microns, the radius rₛ of the stress member 106 is 17.5 microns, and the radius R_{cs} to the center of the stress member 106 is 27.5 microns. As can be seen in FIG. 6, the characteristic width w_{oc} of the cladding is 45 microns at the angular orientation φ of −90° and 90° in which the slow axis is arranged vertically. Further, because the core 102 is obscured by stress members 106, the characteristic width w_{cr} of the core 102 is not observed at angular orientations φ of less than about −50.5° and greater than about 50.5°. Thus, by measuring the characteristic widths w_{oc} and/or w_{cr} of the cladding 104 and core 102, the angular orientation φ of the slow axis of the PM optical fiber 100 can be determined.

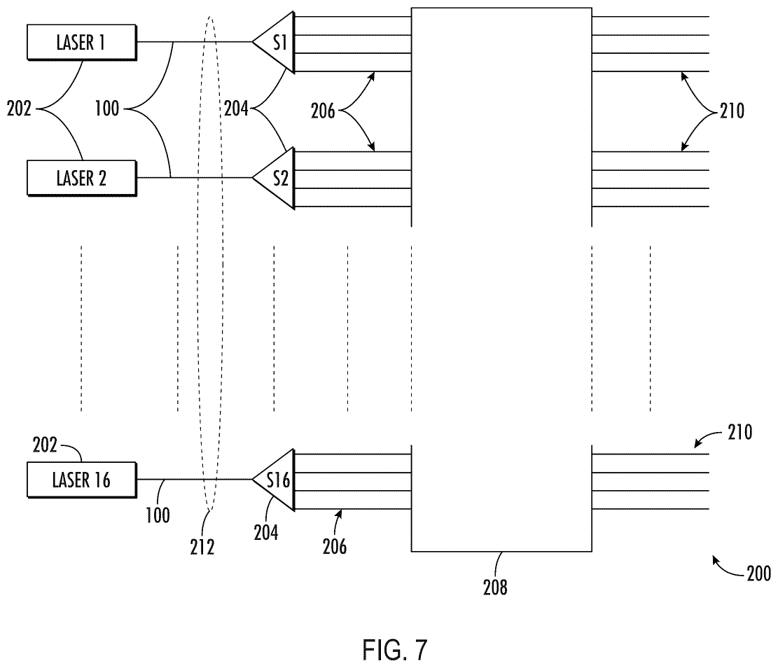

The orientation of the PM optical fiber 100 is relevant for making optical connections. In particular, PM optical fibers 100 are often directly connected to a laser for initial propagation of an optical signal. For example, as shown in the schematic in FIG. 7, an optical system 200 may include a plurality of lasers 202 that generate signals. A PM optical fiber 100 may be connected at a first end to the laser 202 to receive optical signals from the laser 202. In the embodiment shown in FIG. 7, a second end of the PM optical fiber 100 is connected to a splitter 204, which is a 1×4 splitter. The splitter 204 divides the optical signal carried by the PM optical fiber 100 into four signals carried by four receiver fibers 206. The receiver fibers 206 may then carry the signals to a switch 208, which routes the signals to desired transmitter fibers 210. An example embodiment of the optical system 200 contains sixteen lasers 202, sixteen PM optical fibers 100, sixteen splitters 204, sixty-four receiver fibers 206, a sixty-four fiber switch 208, and sixty-four transmitter fibers 210. According to one aspect, the PM optical fibers 100 may be arranged in a fiber array unit 212 in order to conveniently make a connection with the sixteen lasers 202.

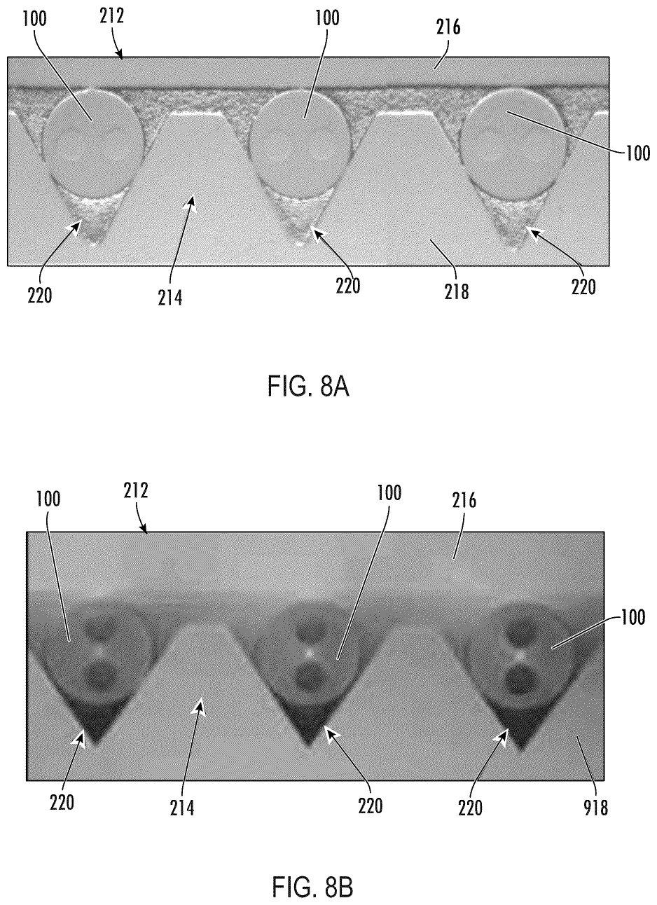

FIGS. 8A and 8B depict portions of endfaces 214 of a fiber array unit 212. As can be seen in these figures, the PM optical fibers 100 are arranged between a top plate 216 and a bottom plate 218. Formed on the bottom plate 218 are a plurality of grooves 220, which are V-shaped. The PM optical fibers 100 are seated in the grooves 220, and the top plate 216 is joined to the bottom plate 218 to secure the PM optical fibers 100 within the fiber array unit 212. As can be seen in FIG. 8A, the PM optical fibers 100 are each arranged in a horizontal, 0° orientation, and as can be seen in FIG. 8B, the PM optical fibers 100 are each arranged in a vertical, 90° orientation. Conventionally, in order to provide the correct orientation for the polarized optical fiber, the individual PM optical fibers 100 had to be arranged individually by hand in each of the grooves 220 in the proper orientation, which is time-consuming and error prone. This is but one illustrative example of an application in which a way to maintain the orientation of multiple PM optical fibers 100 is desirable.

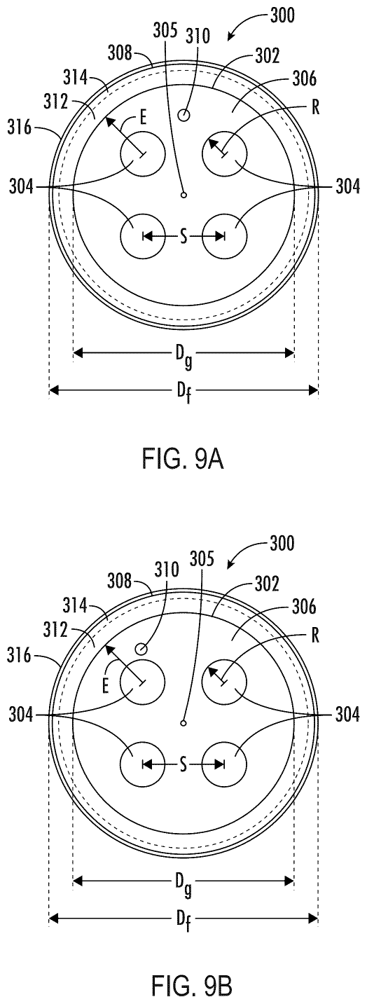

In a related context, a multicore optical fiber 300 as shown in FIGS. 9A and 9B would also benefit from having a consistent orientation. Referring to FIGS. 9A and 9B, the terminal end of multicore optical fibers 300 having an inner glass region 302 containing a plurality of core regions 304 surrounded by a common outer cladding 306 and an outer coating layer 308 are illustrated, according to various examples. The plurality of core regions 304 each define a core-portion of inner glass region 302 and may be glass core regions each having a circular shape in cross-section and spaced apart from one another.

As will be discussed more fully below, each core region 304 includes a core, (optionally) an inner cladding surrounding the core, and a trench. In the core region, the core has a higher refractive index than the inner cladding, and the inner cladding has a higher refractive index than the trench. Thus, the trench relates to a depression in the refractive index of the core region 304. By separating the core from trench with the inner cladding, the trench can have a large trench volume. However, in some embodiments, the inner cladding may be omitted such that the trench is adjacent to the core. The common outer cladding 306 is shown having a generally circular end shape or cross-sectional shape in the embodiments illustrated. The plurality of core regions 304 each extend in a cylindrical shape through the length of the multicore optical fiber 300 and are illustrated spaced apart from one another and are surrounded and separated by the common outer cladding 306. The multicore optical fiber 300 contains at least two core regions 304, preferably at least three core regions 304, and more particularly at least four core regions 304, and therefore has a plurality of core regions 304.

The core regions 304 and common outer cladding 16 may be made of glass or other optical fiber material and may be doped suitably for an optical fiber. In one embodiment, each core region 304 is comprised of germania-doped silica core, an inner cladding and a fluorine-doped silica trench. In one embodiment, the shape of the multicore optical fiber 300 may be a circular end shape or circular cross-sectional shape as shown in FIGS. 9A and 9B. According to other embodiments, end and cross-sectional shapes and sizes may be employed including elliptical, hexagonal and various polygonal forms. The multicore optical fiber 300 includes a plurality of core regions 304, each capable of communicating light signals between transceivers including transmitters and receivers which may allow for parallel processing of multiple signals. The multicore optical fiber 10 may be used for wavelength division multiplexing (WDM) or multi-level logic or for other parallel optics of spatial division multiplexing. The multicore optical fiber 300 may advantageously be aligned with and connected to various devices in a manner that allows for easy and reliable connection so that the plurality of core regions 304 are aligned accurately at opposite terminal ends with like communication paths in connecting devices.

The multicore optical fiber 300 illustrated in FIG. 9A has an inner glass region 302 having four (4) circular-shaped core regions 304 arranged in a 2×2 array and surrounded by a common outer cladding 306. Each of the circular-shaped core regions 304 has an outer radius R greater than 11 microns, and the outer radius R may be greater than 13 microns, where the outer radius R of each core region 304 is measured with respect to its center as shown in FIGS. 9A and 9B. The outer radius R may have an upper limit of 20 microns in certain embodiments. Adjacent core regions 304 are spaced apart from each other by a separation distance S, which is defined as a distance between the centers of adjacent core regions 304. Separation distance S between centers of adjacent core regions 304 may be greater than 35 microns, greater than 40 microns, or greater than 45 microns, according to various embodiments. Separation distance S may be less than 48 microns which may correspond to a core center to fiber edge distance E of 28 microns in one example, or may be less than 46 microns which may correspond to a core center to fiber edge distance E of 30 microns in another example. The common outer cladding 306 is also shown having an outer circular shape defining the shape of the inner glass region 302 with a glass diameter D_{g}. In an embodiment, the glass diameter D_{g} is between 120 microns and 130 microns.

In the embodiments shown in FIGS. 9A and 9B, the multicore optical fiber 300 has an inner glass region 302 having the core regions 304 arranged in a 2×2 array and centered within and about the center of inner glass region 302. As such, the core regions 304 are spaced apart and centered within the inner glass region 302 such that they are symmetric about and evenly spaced from a center 305 of inner glass region 302. In FIG. 9A, the inner glass region 302 includes a marker 310. It should be appreciated that one or more markers may be employed to assist with identifying the alignment of the core regions 304. The marker 310 is shown located at a symmetric position with respect to a pair of the core regions 304 in FIG. 9A, and is shown located adjacent to or closer to one core region 304 in FIG. 9B to mark that particular core region 304. The marker 310 may be employed to determine the alignment of the core regions 304 for interconnection with other fibers or connection devices. The marker 310 may be made of a fluorine-doped glass having a refractive index that is lower than that of silica.

The multicore optical fiber 300 includes an outer coating layer 308 which surrounds and encapsulates the inner glass region 302. The outer coating layer 308 is shown in FIGS. 9A and 9B as having a primary or inner coating layer 312 that immediately surrounds the inner glass region 302 and a secondary or outer coating layer 314 that immediately surrounds the primary coating layer 312. The coating layer 308 may further include a tertiary layer 316 (e.g., ink layer) optionally surrounding or directly adjacent to the secondary coating layer 314.

The inner glass region 12 has an overall cross-sectional diameter D_{g} which may be in the range of 120-130 microns, according to one example. The outer coating layer 20 may have a thickness in the range of 22-45 microns, or in the range of 22-40 microns, or in the range from 22-35 microns. The primary coating layer 22 may have a thickness in the range of 12-25 microns, or in the range from 12-22 microns, or in the range from 12-19 microns. The secondary coating layer 24 may have a thickness in the range of 10-20 microns, or in the range from 10-18 microns, or in the range from 10-16 microns. The optional tertiary coating layer 25 may have a thickness equal to or less than 10 microns, more particularly equal to or less than 5 microns, and more particularly in the range of 2-5 microns. The coated multicore optical fiber 10 has an overall fiber diameter D_{f} equal to or less than 200 microns. More specifically, the overall diameter D_{f} may be in the range of 170-200 microns, or in the range of 170-190 microns, or in the range of 180-200 microns.

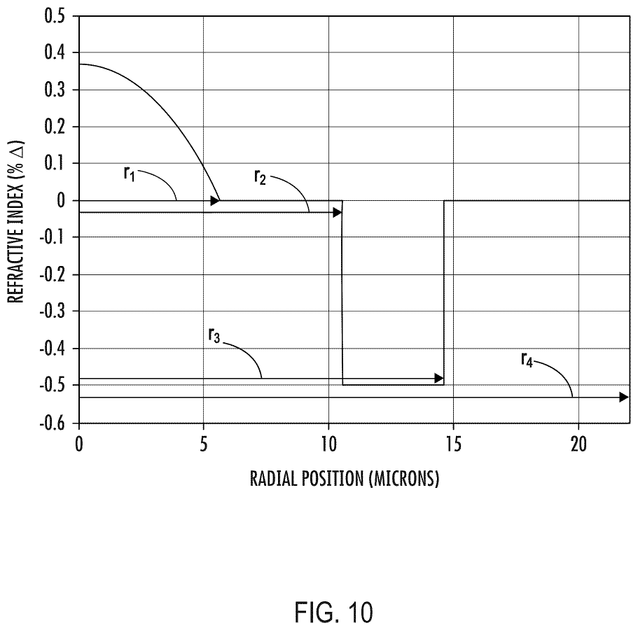

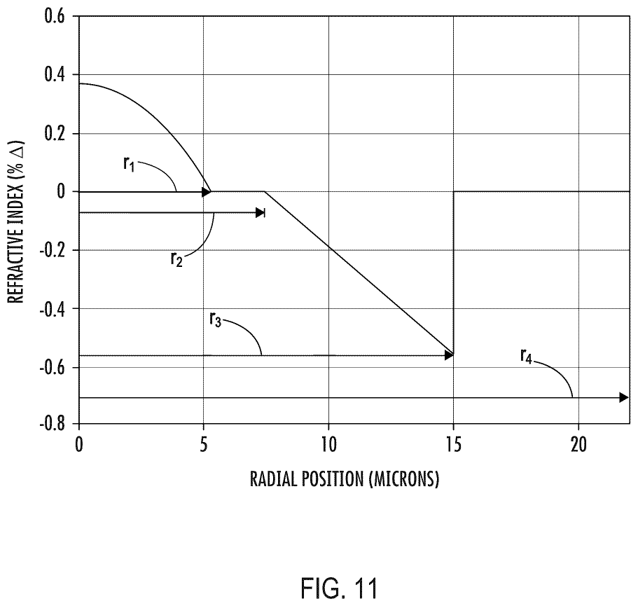

FIG. 10 depicts a relative refractive index profile from the center of a core region 304 to an edge of the common outer cladding 106. The relative refractive index was calculated according to equation (1), above, using the common outer cladding 106 refractive index as the reference refractive index. In particular, FIG. 10 depicts the relative refractive index design profile for an example embodiment having a graded index alpha core region and a rectangular trench design extending from a radius of about 10.5 microns to about 14.5 microns. In FIG. 11, a relative refractive index design profile is shown with a graded index alpha core region and a triangular trench design extending on a decreasing ramp from a radius of about 7.5 microns to about 15 microns. For each relative refractive index profile, the radius r₁ refers to a radius of the core of the core region 304, r₂ refers to the radius of an inner cladding of the core region 304, r₃ refers to the radius of a depressed region or trench of the core region 304, and r₄ refers to the distance E to the edge of the outer cladding region 306.

In one aspect, the trench of the core region 304 can be characterized by a trench volume of greater than about 30% Δ-μm². In one aspect, the trench of the core region 304 can have a trench volume of greater than about 30% Δ-μm², greater than about 40% Δ-μm², greater than about 50% Δ-μm², or greater than about 60% Δ-μm². In some aspects, the trench of the core region 14 has a trench volume of less than about 90% Δ-μm², less than about 85% Δ-μm², less than about 80% Δ-μm², less than about 75% Δ-μm², less than about 70% Δ-μm², less than about 65% Δ-μm², or less than about 60% Δ-μm².

The trench volume V is defined for a depressed index region according to equation (4):

$$V = \vert 2 {\int }_{{r}_{Trench , inner}}^{{r}_{Trench , outer}} ( {Δ}_{Trench} ( r ) - {Δ}_{c} ) rdr \vert \qquad ( 4 )$$

where r_{Trench,inner} is the inner radius of the trench cladding region, r_{Trench,outer} is the outer radius of the trench cladding region, Δ_{Trench}(r) is the relative refractive index of the trench cladding region, and Δ_{c} is the average relative refractive index of the common outer cladding region 106 of the glass fiber. In embodiments in which a trench is directly adjacent to the core, r_{Trench,outer} is the outer radius of the core (r₁), r_{Trench,outer} is the outer radius of the trench (r₃), and Δ_{Trench} is Δ₃(r). In embodiments in which a trench is directly adjacent to an inner cladding region, r_{Trench,inner} is the outer radius of the inner cladding (r₂), r_{Trench,outer} remains the outer radius of the trench (r₃), and Δ_{Trench} is Δ₃(r). Trench volume is defined as an absolute value and has a positive value. Trench volume is expressed herein in units of % Δ-micron², % Δ-μm², or %-micron², %-μm², whereby these units can be used interchangeably.

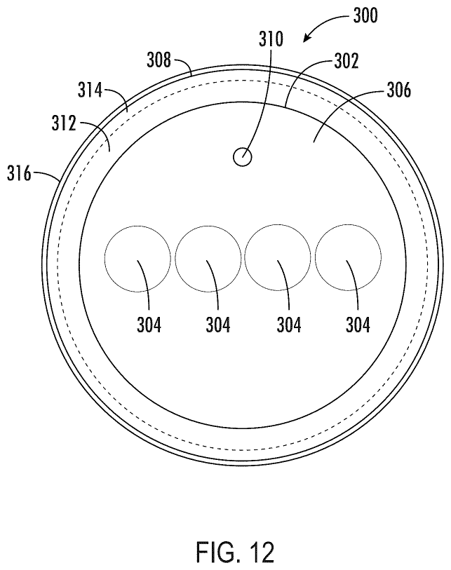

According to another embodiment of the multicore optical fiber 300 shown in FIG. 12, the core regions 304 are arranged in a line across the glass region 302. As with the embodiments described above, the core regions 304 are surrounded by a common cladding 306. The core regions 304 include a core and a trench, optionally with an inner cladding disposed between the core and the trench. The glass region 302 also includes a marker 310 disposed on one side of the line of core regions 304, in particular located between the second and third core region 304. Outside of the glass region 302 is a coating layer 308. In one or more embodiments, the coating layer 308 includes a primary or inner coating 312 adjacent the glass region 302 and a secondary or outer coating 314 adjacent the primary coating 312. Optionally, the coating layer 308 includes a tertiary coating 316, such as an ink layer for identification.

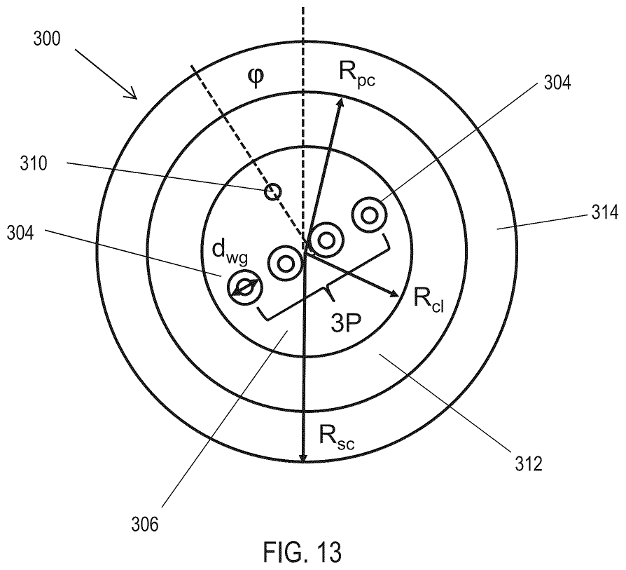

Having described the structure of embodiments of the multicore optical fiber 300, the orientation of the multicore optical fibers 300 is now described. FIG. 13 depicts geometric parameters used for determining the angular orientation φ of a 1×4 multicore optical fiber 300. In particular, the multicore optical fiber 300 includes a radius R_{sc} which is the radius of the secondary coating 314. R_{pc} is the radius of the primary coating 312. R_{cl} is the radius of the cladding 306. The parameter d_{wg} is the diameter of the waveguide or core region 304. The parameter P refers to the pitch of the core regions 304, i.e., the distance between the center of adjacent core regions 304, and thus, 3P is the distance between the two farthest centers of the 1×4 array of core regions 304. The marker 310 of the multicore optical fiber 300 is arranged at an angle φ relative to vertical or 0°.

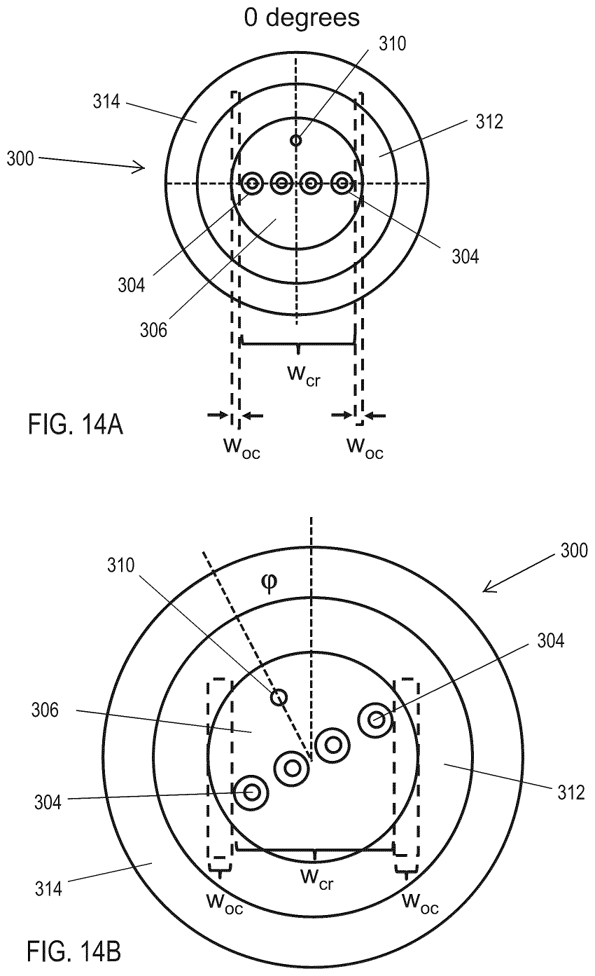

FIGS. 14A and 14B depict the 1×4 multicore optical fiber 300 in two different angular orientations. In FIG. 14A, the 1×4 multicore optical fiber 300 is arranged with the marker 310 at the vertical (φ=0°) position. At this angular orientation, the cladding 306 has characteristic widths w_{oc} that is at a minimum, and the core regions 304 have a characteristic width w_{cr} that is at a maximum. In FIG. 14B, the marker 310 deviates from the vertical position by the angle φ, and the characteristic width w_{oc} of the cladding increases while the characteristic width w_{cr} of the core regions 304 decreases. The characteristic widths w_{oc} and w_{cr} can be determined according to the following equations (5) and (6):

$${w}_{oc} = \frac{1}{2} [ 2 {R}_{cl} - {d}_{wg} - 3 P cos ( φ ) ] \qquad ( 5 )$$

$${w}_{cr} = {d}_{wg} + 3 P cos ( φ ) \qquad ( 6 )$$

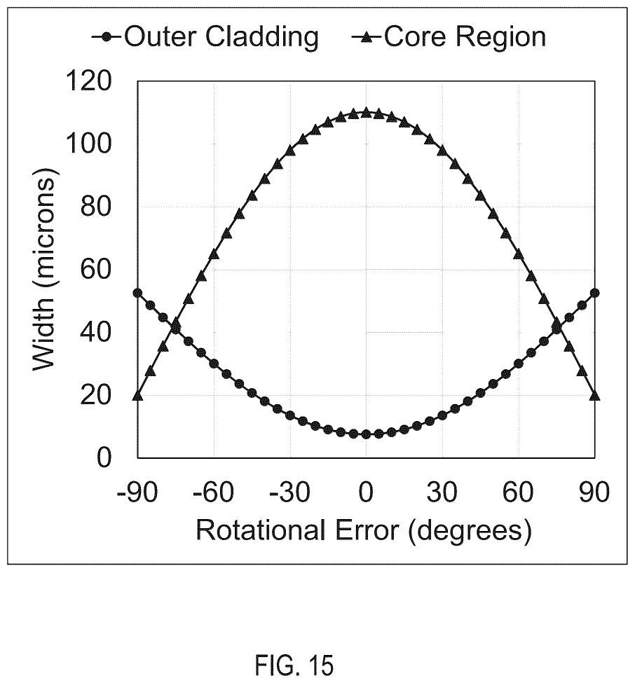

Using these equations, the characteristic widths w_{oc} and w_{cr} of the cladding 306 and core regions 304 can be determined as a function of angular orientation φ (referred to as “rotational error”) as shown in FIG. 15. To generate the plot, a multicore optical fiber 300 having a pitch P of core regions of 30 microns and a diameter d_{wg} of each core region 304 of 20 microns was considered. In the plot of FIG. 15, the maximum w_{oc} is plotted without subtracting the marker 310, which would be visible in one region of the cladding 306 in the horizontal (φ=−90° or 90°) positions. The characteristic width w_{oc} of the cladding 306 is at a maximum when the 1×4 multicore optical fiber 300 is arranged with the marker 310 located at the horizontal (φ=−90° or 90°) position and at a minimum when the marker is arranged in the vertical (φ=0°) position. In contrast, the characteristic width w_{cr} of the core regions 304 is at a maximum when the marker 310 is arranged in the vertical (φ=0°) position and at a minimum when the marker 310 is arranged in a horizontal (φ=−90° or 90°) position. By side-imaging the multicore optical fiber 300 from along the length, the characteristic width w_{oc} and/or w_{cr} of the cladding 306 and/or core regions 304 can be measured to determine the angular orientation φ of the multicore optical fiber 300.

Further, during side-imaging, the multicore optical fiber 300 can be over-rotated in one direction until the marker 310 is visible to distinguish the orientation of the multicore optical fiber 310. That is, the characteristic widths w_{oc} and w_{cr} will be the same when the marker 310 is in either vertical (φ=0° or 180°) position above or below the core regions 304. By over-rotating the multicore optical fiber 300 clockwise, for example, the side of the core regions 304 on which the marker 310 becomes visible will identify whether the marker 310 is over or under the core regions 310. Thereafter, the multicore optical fiber 300 can be counter-rotated or further rotated to position the marker 310 in the desired position as identified by the characteristic width w_{oc}, w_{cr} of the cladding 306 or core region 304.

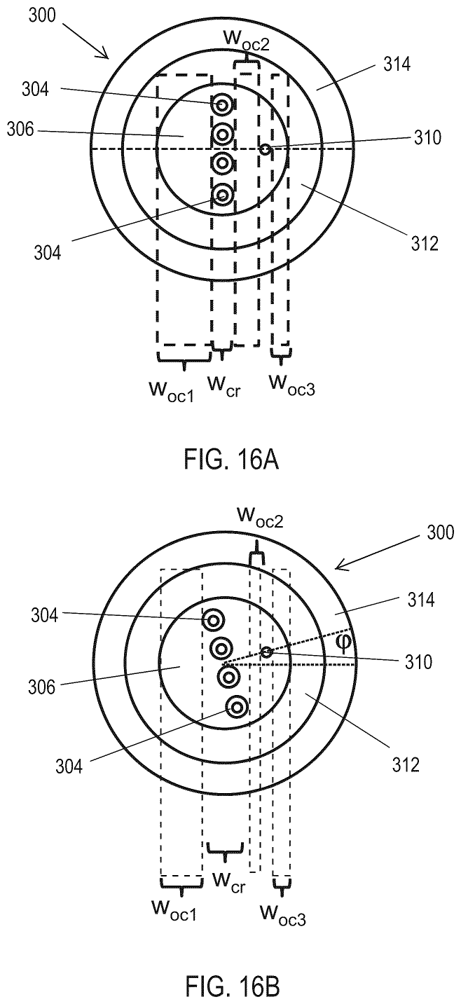

FIGS. 16A and 16B depict the 1×4 multicore optical fiber 300 with the orientation of the marker 310 in the horizontal position used as a reference for the angular orientation φ of the multicore optical fiber 300. As shown in FIG. 16A, the multicore optical fiber 300 is arranged with core regions 304 vertically oriented and the marker 310 arranged to the right, corresponding to an angular orientation φ of 0°. In this orientation, the cladding 306 has three characteristic widths w_{oc1}, w_{oc2}, and w_{oc3}, which correspond to the width of the cladding 306 on the side of the core regions 304 without the marker 310, the width of the cladding 306 between the core regions 304 and the marker 310, and the width of the cladding 306 outside of the marker 310, respectively. As with the previous example, the characteristic width of the core regions 304 is w_{cr}. FIG. 16B depicts the multicore optical fiber 300 where the angular orientation of the core regions 304 deviates from vertical by an angle φ. As the angle increases, the first and second characteristic widths w_{oc1}, w_{oc2} of the cladding decrease, and the third characteristic width w_{oc3} of the cladding 306 increases. As the angle φ increases, the first characteristic width w_{oc1} of the cladding 306 will continue to decrease until the horizontal position of the core regions 304 is reached. The second characteristic width w_{oc2} will disappear when the core regions 304 eclipse the marker 310, and the third characteristic width w_{oc3} of the cladding 306 will increase until the core regions 304 eclipse the marker 310 and then will decrease until the core regions 304 reach the horizontal position.

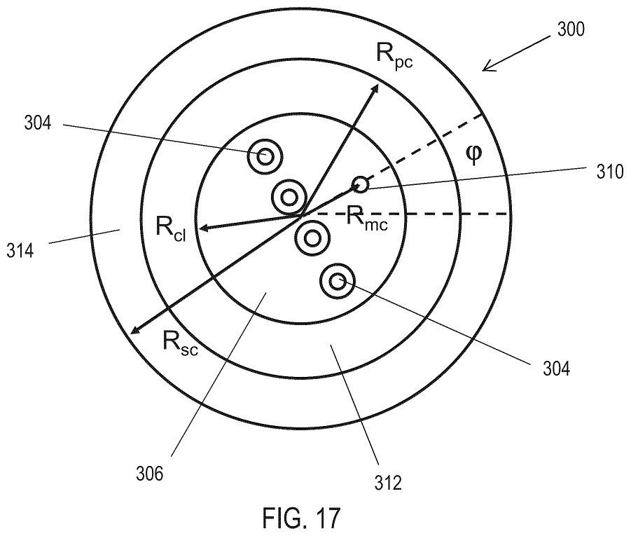

FIG. 17 depicts geometric parameters used to calculate the characteristic widths w_{oc1}, w_{oc2}, w_{oc3}, w_{cr} of the cladding 306 and the core regions 304 based on the angular position of the marker 310. In this example embodiment, the multicore optical fiber 300 includes a radius R_{sc} which is the radius of the secondary coating 314. R_{pc} is the radius of the primary coating 312. R_{cl} is the radius of the cladding 306. The parameter d_{wg} is the diameter of the waveguide or core region 304. The parameter P refers to the pitch between the center of adjacent core regions 304, and thus, 3P is the distance between the two farthest centers of the 1×4 array of core regions 304. The parameter R_{mc} is the radius to the center of the marker 310, and d_{mc} is the diameter of the marker 310. The marker 310 of the multicore optical fiber 300 is arranged at an angle φ relative to horizontal or 0°.

Using these parameters, the characteristic widths w_{oc1}, w_{oc2}, w_{oc3}, and w_{cr} can be determined according to the following equations (7)-(10):

$${w}_{oc 1} = \frac{1}{2} [ 2 {R}_{cl} - {d}_{wg} - 3 P sin ( \vert φ \vert ) ] \qquad ( 7 )$$

$${w}_{cr} = {d}_{wg} + 3 P sin ( \vert φ \vert ) \qquad ( 8 )$$

$${w}_{oc 3} = {R}_{cl} - {R}_{mc} cos ( φ ) - \frac{{d}_{mc}}{2} \qquad ( 9 )$$

$${w}_{oc 2} = {R}_{mc} cos ( φ ) - \frac{{d}_{mc}}{2} - \frac{{d}_{wg}}{2} - \frac{3 P}{2} sin ( \vert φ \vert ) \qquad ( 10 )$$

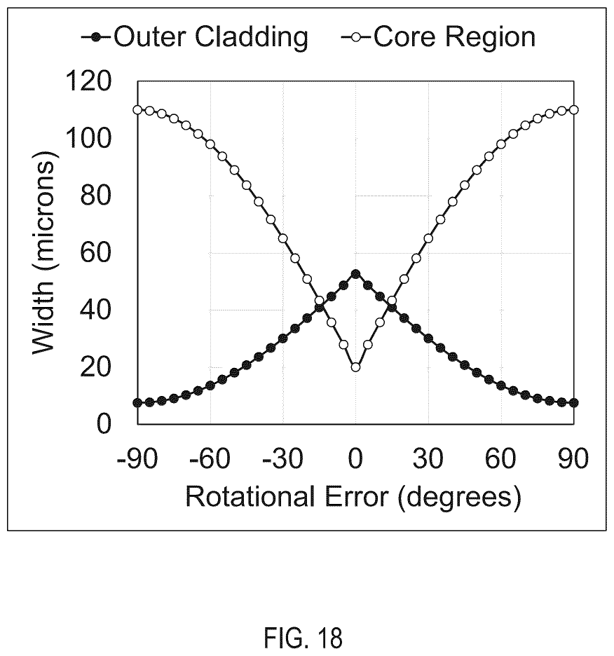

From these equations, the characteristic widths w_{oc1} and w_{cr} of the cladding 306 and core regions 304 can be determined as a function of angular orientation φ (referred to as “rotational error”) as shown in FIG. 18. To generate the plot, a multicore optical fiber 300 having a pitch P of core regions of 30 microns and a diameter d_{wg} of each core region 304 of 20 microns was considered. The characteristic width w_{oc1} of the cladding 306 is at a maximum when the 1×4 multicore optical fiber 300 is arranged with the marker 310 located at the horizontal (φ=0°) position and at a minimum when the marker is arranged in the vertical (φ=−90° or 90°) position. In contrast, the characteristic width w_{cr} of the core regions 304 is at a maximum when the marker 310 is arranged in the horizontal (φ=0°) position and at a minimum when the marker 310 is arranged in a vertical (φ=−90° or 90°) position. Thus, by side-imaging the multicore optical fiber 300 from along the length, the characteristic width w_{oc1} and/or w_{cr} of the cladding 306 and/or core regions 304 can be measured to determine the angular orientation φ of the multicore optical fiber 300. Further, as discussed above, the position of the marker 310 above or below the core regions 304 (i.e., in the vertical (φ=−90° or 90°) position) can be determined by identifying which side of core region 304 develops the characteristic widths w_{oc2}, w_{oc3}. That is, as the marker 310 is uncovered by the core regions 304, the development of the characteristic widths w_{oc2}, w_{oc3} will identify the position of the marker 310 in the horizontal position (φ=0° or 180°). Moreover, as discussed above, this potential over-rotation can purposely be done for the identification of the location of the marker 310 so that the multicore optical fiber 300 can be accurately positioned.

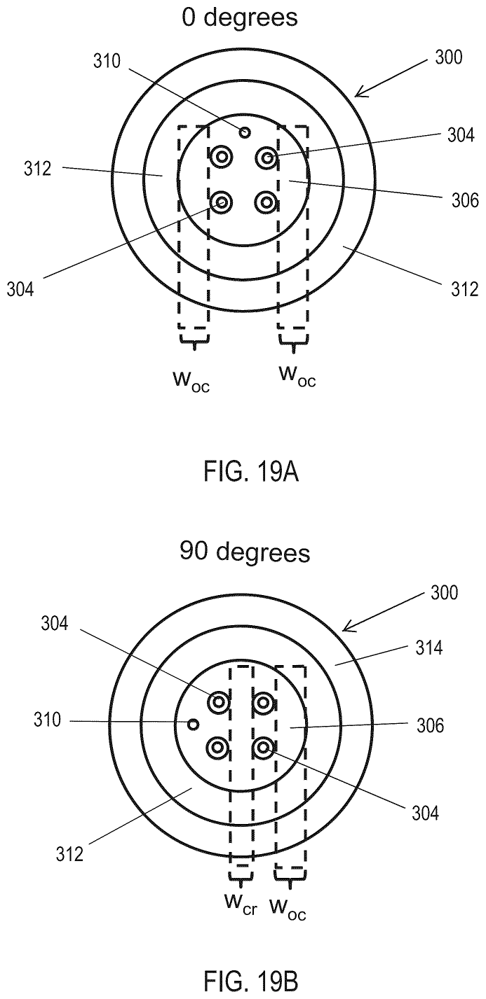

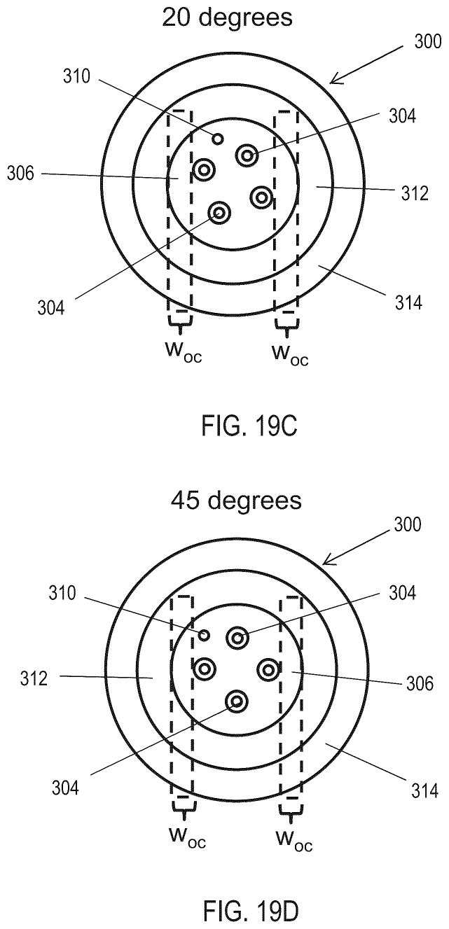

FIGS. 19A-19D depict embodiments of a multicore optical fiber 300 having core regions 304 arranged in a 2×2 array at various different angular orientations. In FIG. 19A, the multicore optical fiber 300 is arranged with the marker 310 in the vertical position (φ=0°). In this position, the cladding 306 has two characteristic widths w_{oc} outside of the core regions 304 that are equal in size. When the multicore optical fiber 300 is rotated so that the marker 310 is located in the horizontal position (φ=90°), one of the characteristic widths w_{oc} of the cladding 306 remains the same, and a characteristic width w_{cr} between core regions 304 is developed. Because of the positioning of the marker 310 in the horizontal position, one region of cladding 306 may not be discernible. Between the vertical and horizontal positions, the characteristic width w_{oc} of each region of cladding 306 outside the core regions 304 decreases until an angular orientation φ of 45° is reached. FIG. 19C depicts the multicore optical fiber 300 with the marker 310 oriented at an angle of 20° relative to vertical. As can be seen, the marker 310 is still eclipsed by the core regions 304, and thus, both regions of cladding 306 have discernible characteristic widths w_{oc}. Further, the characteristic width w_{oc} is smaller than in the 0° and 900 positions. As shown in FIG. 19D, the marker 310 of the multicore optical fiber 300 is oriented at the 45° position. In this position, the characteristic widths w_{oc} of the cladding 306 are still discernible because the marker 310 is eclipsed by the core regions 310. Further, in the 45° orientation, the characteristic width w_{oc} of one region of cladding 306 reaches a minimum, whereas the characteristic width w_{oc} of the other region of cladding 306 will continue to decrease in size when the marker 310 is uncovered by the core regions 304 at an angular orientation greater than 45°.

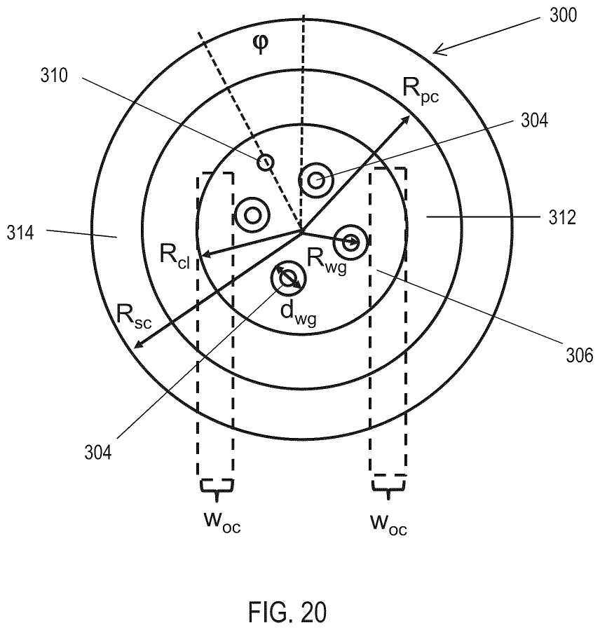

FIG. 20 depicts geometric parameters of the 2×2 multicore optical fiber 300 from which the characteristic width w_{oc} of the cladding 306 can be calculated. In this example embodiment, the multicore optical fiber 300 includes a radius R_{sc} which is the radius of the secondary coating 314. R_{pc} is the radius of the primary coating 312. R_{cl} is the radius of the cladding 306. The parameter d_{wg} is the diameter of the waveguide or core region 304. The parameter R_{wg} is the radius to the center of the core region 304. The marker 310 of the multicore optical fiber 300 is arranged at an angle φ relative to vertical or 0°.

Using these geometric parameters the characteristic width w_{oc} of the cladding region 306 can be calculated according to the below equation (11):

$${w}_{oc} = {R}_{cl} - {R}_{wg} cos ( 45 ° - \vert φ \vert ) - \frac{{d}_{wg}}{2} \qquad ( 11 )$$

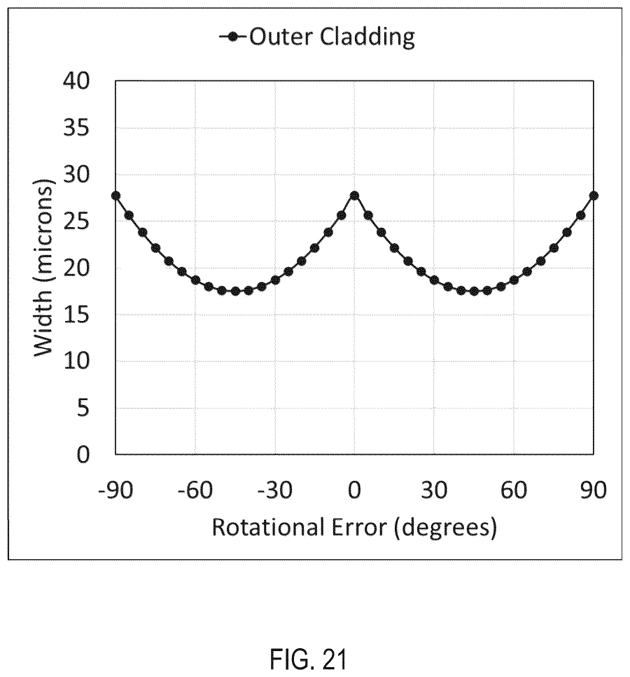

From this equation, the characteristic width w_{oc} of the cladding 306 can be determined as a function of angular orientation φ (referred to as “rotational error”) as shown in FIG. 21. To generate the plot, a multicore optical fiber 300 having a radius R_{wg} to the center of each core region of 35 microns and a diameter d_{wg} of each core region 304 of 20 microns was considered. The characteristic width w_{oc} of the cladding 306 is at a maximum when the 2×2 multicore optical fiber 300 is arranged with the marker 310 located at the vertical (φ=0°) and at the horizontal (φ=−90° or 90°) positions. The characteristic width w_{oc} of the cladding 306 is at a minimum when the marker is arranged at the intermediate ((φ=−45° or 45°) position. Thus, by side-imaging the multicore optical fiber 300 from along the length, the characteristic width w_{oc} of the cladding 306 can be measured to determine the angular orientation φ of the multicore optical fiber 300.

Additionally, over-rotation can be used to determine whether the marker 310 is above or below the 2×2 array of core regions 304. When the marker 310 is in the horizontal (φ=−90° or 90°) position, the side of the core regions 304 on which marker 310 is located and the direction (clockwise or counterclockwise) in which the multicore optical fiber 300 was rotated to put the marker 310 in the horizontal position will inform whether the multicore optical fiber 300 needs further rotation or counterrotation to put the marker 310 in the desired position.

In view of the foregoing discussion of at least two contexts in which knowing and maintaining the orientation of an optical fiber, such as a PM optical fiber 100 or a multicore optical fiber 300, is desirable, the following discussion describes an optical fiber ribbon and a method of producing same that provides such orientation. In particular, according to the present disclosure, the PM optical fibers 100 or multicore optical fibers 300 are arranged in intermittently bonded optical fiber ribbons, which maintain the proper orientation of the respective PM optical fibers 100 or multicore optical fibers 300 for such applications as described. Also disclosed is a method of determining orientation of the PM optical fibers 100 or multicore optical fiber 300 when forming the intermittently bonded optical fiber ribbon.

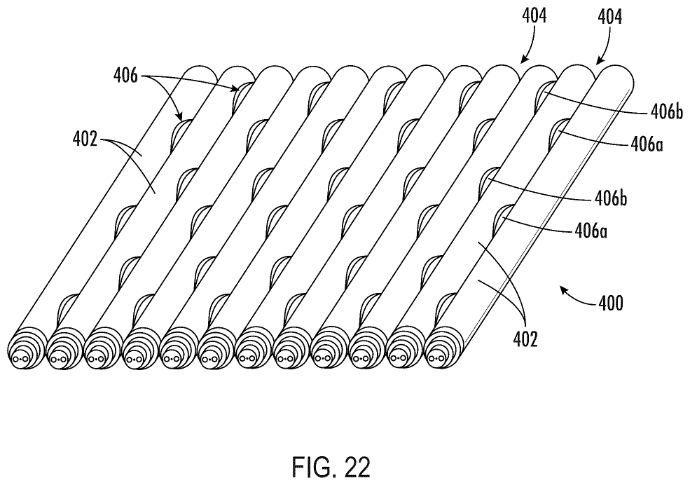

Referring now to FIG. 22, an embodiment of an intermittently bonded optical fiber ribbon 400 is depicted. The optical fiber ribbon 400 includes a plurality of optical fibers 402 (such as PM optical fibers 100 or multicore optical fibers 300). In one or more embodiments, the optical fibers 402 are arranged in subunits 404 including at least two optical fibers 402. The optical fibers 402, including optical fibers 402 in the subunits 404, all have the same orientation with respect to an identifiable third region within the cladding (e.g., with stress members 106 of the PM optical fibers 100 oriented in the same direction or with the marker 310 of the multicore optical fibers 300 at the same angular position). The intermittently bonded optical fiber ribbon 400 includes at least one set of intermittent bonds 406. For example, the optical fibers 402 of the subunits 404 may be intermittently bonded and/or the subunits 404 may be intermittently bonded.

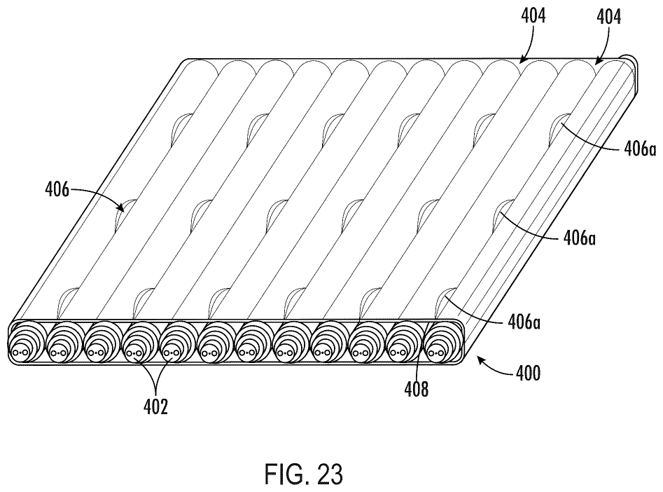

As shown in FIG. 22, the optical fiber ribbon 400 includes first intermittent bonds 406a joining optical fibers 402 into subunits 404 and second intermittent bonds 406b joining the subunits 404. In one or more other embodiments, such as shown in FIG. 23, the optical fiber ribbon 400 may include first intermittent bonds 406a joining optical fibers 402 into subunits 404, and the subunits 404 are arranged into an optical fiber ribbon 100 using a continuous layer ribbon matrix 408.

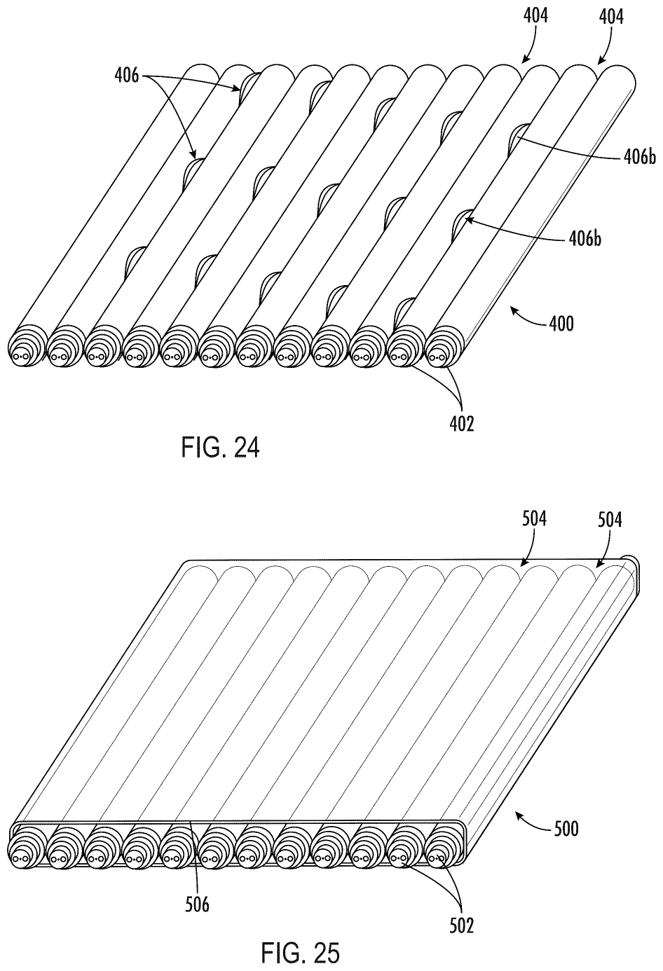

In one or more other embodiments, such as shown in FIG. 24, the optical fibers 402 of the subunits 404 are continuously coated along their length to join them together in a subunit 404. The continuously coated subunits 404 are then joined with second intermittent bonds 406b to create the intermittently bonded optical fiber cable 400.

Notwithstanding the foregoing, the present disclosure regarding determining and maintaining the orientation of, e.g., PM optical fibers 100 and multicore optical fibers 300 applies as well to non-intermittently bonded optical fiber ribbons. For example, in one or more embodiments, such as the embodiment of FIG. 25, an optical fiber ribbon 500 includes a plurality of optical fibers 502 that are joined into continuously coated subunits 504, which are then joined by a continuous coating matrix layer 506 to form the optical fiber ribbon 500.

Having described the structure of various forms of optical fiber ribbons 400, 500, a method and system for orienting and joining the optical fibers (such as PM optical fibers 100 or multicore optical fibers 300) is now described.

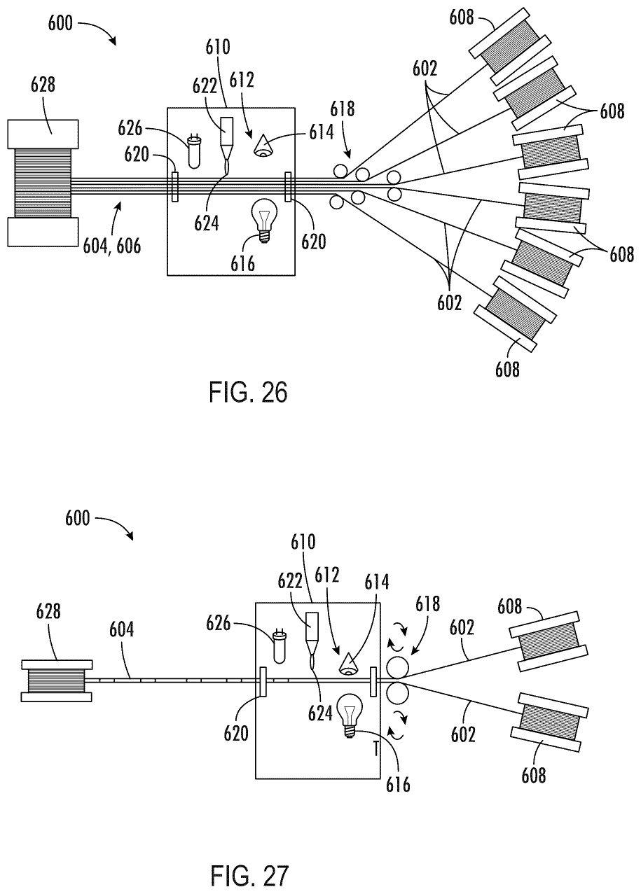

FIG. 26 depicts a first system 600 for joining two or more optical fibers 602 into intermittent or continuously bonded subunits 604 or ribbons 606. The system 600 includes a plurality of payoff reels 608 having spooled optical fibers 602 (e.g., PM optical fibers 100 or multicore optical fibers 300). The optical fibers 602 are pulled into a bonding chamber 610. Disposed within the bonding chamber 610 is an imaging system 612. In one or more embodiments, the imaging system 612 includes a camera 614, such as a CCD camera, and a light source 616 that illuminates the optical fibers 602. As can be seen in FIG. 26, the camera 614 and the light source 616 are arranged on opposite sides of the optical fibers 602 so that light from the light source shines through the optical fibers 602 for capturing by the camera 614. In embodiments, the light source 616 is a coherent light source. In one or more embodiments, the coherent light source is a laser, or the coherent light source may comprise an incoherent light source filtered through a pinhole aperture and a wavelength filter to provide coherent light.

The imaging system 612 determines the orientation of the optical fibers 602 as described above. That is, the imaging system 612 determines an orientation of the optical fibers 602 based on the number and widths of various strips associated with the components of the optical fibers 602 (e.g., associated with the core, the cladding, or a third identifiable region, such as a stress member or marker depending on the type of optical fiber 602). In more detail, the imaging system 612 continuously collects a side view of the optical fibers 602 as they move through the chamber 610, and these images are analyzed using an image analysis software stored on a memory of a control system of the chamber 610 and executed by a processor of the control system. Based on the determined width of the relevant strip or strips analyzed, the control system independently adjusts the positioning of each optical fiber 602 as the optical fibers 602 are fed into the chamber 610. For example, the orientation of the optical fibers 602 can be independently adjusted by sending a signal from the control system to a pulley system 618 to adjust the rotational angle at which each individual optical fiber 602 is fed into the chamber 610. In one or more embodiments, the optical fibers 602 are independently adjusted until a desired characteristic width for each optical fiber 602 is substantially achieved. In one or more such embodiments, each optical fiber 602 is rotated until the characteristic width is within 10%, within 5% or within 2% of the desired characteristic width (i.e., the characteristic width associated with the desired angular orientation of the identifiable third region).

Clamps 620 within the chamber 610 maintain the optical fibers 602 in the proper orientation once the proper orientation is achieved. An applicator 622 intermittently or continuously deposits bonding material 624 between or around the optical fibers 602. Thereafter, the bonding material 624 is cured. In one or more embodiments, the bonding material 624 is cured using a UV light source 626. In such embodiments, the UV light source 626 may be an LED light source. In one or more embodiments, the chamber 610 or a portion thereof may incorporate a nitrogen purge to control the level of oxygen at the curing surface of the bonding material 624. After curing, the intermittently or continuously bonded optical fibers 602 exit the chamber 610 and are taken up on spool 628, which collects the aligned and bonded optical fibers 602.

FIG. 27 depicts another embodiment of a system 600 specifically configured to form subunits 630 from the optical fibers 602 (e.g., PM optical fibers 100 or multicore optical fibers 300). In this embodiment of the system 600, there are only two payoff reels 608 that feed the optical fibers 602 into the chamber 610. Within the chamber 610, the imaging system 612 determines the orientation of the optical fibers 602 as described above, and if necessary, the pulley system 618 is used to bring the optical fibers 602 into proper orientation. Further, within the chamber 610, the applicator 622 deposits bonding material 624 onto the optical fibers 602. The embodiment depicted shows the applicator 622 applying the bonding material 624 intermittently to form intermittent bonds 632 between the optical fibers 602. Further, as with the previous embodiment, the bonding material 624 is cured, e.g., using a UV light source 626. Thereafter, the subunit 630 exits the chamber 610 and is taken up on the spool 628.

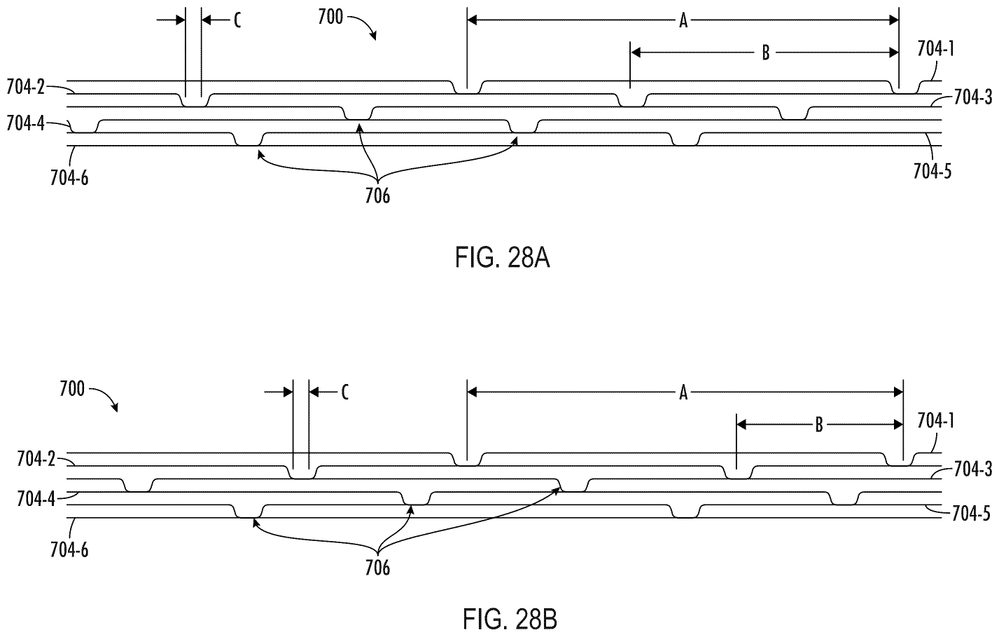

Having described various embodiments of optical fiber ribbons and methods and systems of preparing same, the following discussion relates in particular to various examples of intermittently bonded optical fiber ribbons and ways to apply the bonds between subunits such that the bonds do not overlap along the length of the optical fiber ribbon. FIG. 28A depicts a schematic representation of the intermittent bonding pattern for the optical fiber ribbon 700. In the depiction of FIG. 28A, the lines represent subunits 704 of one or more optical fibers (e.g., PM optical fiber 100 or multicore optical fiber 300), and individual subunits are referenced as 704-1, 704-2, . . . 704-n. In the embodiment shown in FIG. 28A, there are six subunits 704-1, 704-2, 704-3, 704-4, 704-5, 704-6. The regions where one subunit 704 dips to contact an adjacent subunit 704 represent intermittent bonds 706 between the subunits 704. It should be noted that the dips depicted in FIG. 28A are used to illustrate the intermittent bonds 706 and do not indicate that the subunits 704 would actually physically dip at the locations of intermittent bonds 706. In order to describe the intermittent bonding pattern in embodiments, three parameters are utilized. The first parameter “A” refers to the longitudinal distance between intermittent bonds 706 joining a particular pair of subunits 704 (e.g., the longitudinal distance between intermittent bonds 706 joining subunit 704-1 and subunit 704-2). The second parameter “B” refers to the longitudinal offset between the intermittent bonds 706 of adjacent pairs of subunits 704. Thus, for example, second parameter B refers to the offset between the intermittent bond 706 of the subunit pair 704-1, 704-2 and the intermittent bond 706 of the subunit pair 704-2, 704-3. In certain instances, the second parameter B is referred to as a fraction or multiple of the first parameter A. The third parameter “C” refers to the length of each intermittent bond 706. In certain instances, the third parameter C is also referred to as a fraction or multiple of the first parameter A.

The intermittent bonds 706 occur at interfaces between subunits 704. The number of interfaces X is equal to one less than the number (N) of subunits 704 in the optical fiber ribbon 700 (i.e., X=N−1). Thus, for example, an optical fiber ribbon 700 with six subunits 704 will have five interfaces. Particular interfaces may be referenced herein with a slash between the numbered subunits (e.g., the interface between subunit 704-1 and subunit 704-2 may be referenced as “interface 704-1/704-2”). In order to provide an optical fiber ribbon 700 without overlap of intermittent bonds 706, Applicant has found that a direct correlation exists between the divisor of the offset parameter B and the number of interfaces. In particular, no overlap will exist if the offset parameter B is equal to the number of interfaces divided by a divisor that is greater than the number of interfaces. For example, in a six subunit optical fiber ribbon 700, no overlap will exist for an offset parameter B of (⅝)A (i.e., the divisor (8) is greater than the number of interfaces (5)). Additionally, as shown in FIG. 28B, the complement to the fraction (e.g., (⅜)A) will also create an offset that produces no overlap.

In embodiments, the offset parameter B is equal to a fraction of A close to 0.5 that corresponds to the number of interfaces X divided by a divisor equal to 2(X−1). Thus, in embodiments, the offset parameter B is equal to (X/(2(X−1))A or its complement. For example, the offset parameter B for an optical fiber ribbon 700 having twelve subunits 704 and eleven interfaces may be equal to ( 11/20)A or ( 9/20)A.

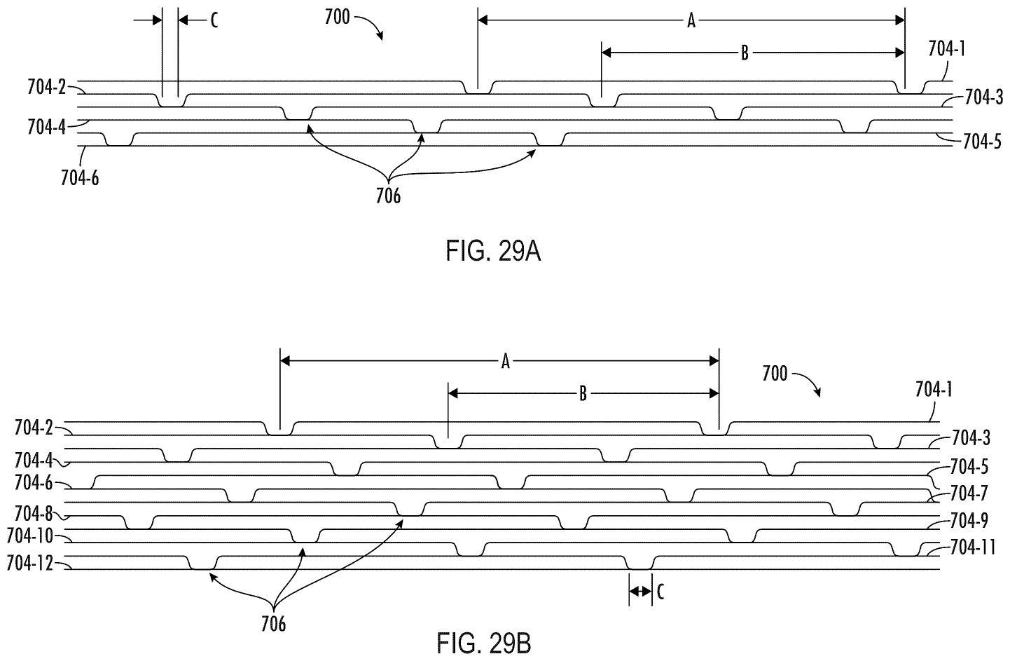

In still other embodiments, the offset parameter B is based on an irrational number, in particular an irrational number that is close to 0.5, in order to avoid overlapping of the intermittent bonds 106. In a particular embodiment, the offset parameter B is based on the golden ratio φ=(1+√5)/2=1.6180339887 . . . . Specifically, the offset parameter B=A/φ. FIGS. 29A and 29B show optical fiber ribbons 700 having six subunits 704 and twelve subunits 704, respectively, in which the offset parameter B is A/φ. As can be seen in FIGS. 29A and 29B, the intermittent bonds 706 do not overlap across the width of the optical fiber ribbon 700, and each intermittent bond 706 has a unique longitudinal position along the length of the optical fiber ribbon 700. In other embodiments, the offset parameter B can be based on such irrational numbers as √2, √3, √5, √7, Euler's number, or t. For example, the offset parameter B may be the first parameter A divided by, e.g., one of the irrational numbers, an integer multiple of one of the irrational numbers, the sum or difference of an integer and one of the irrational numbers, etc.

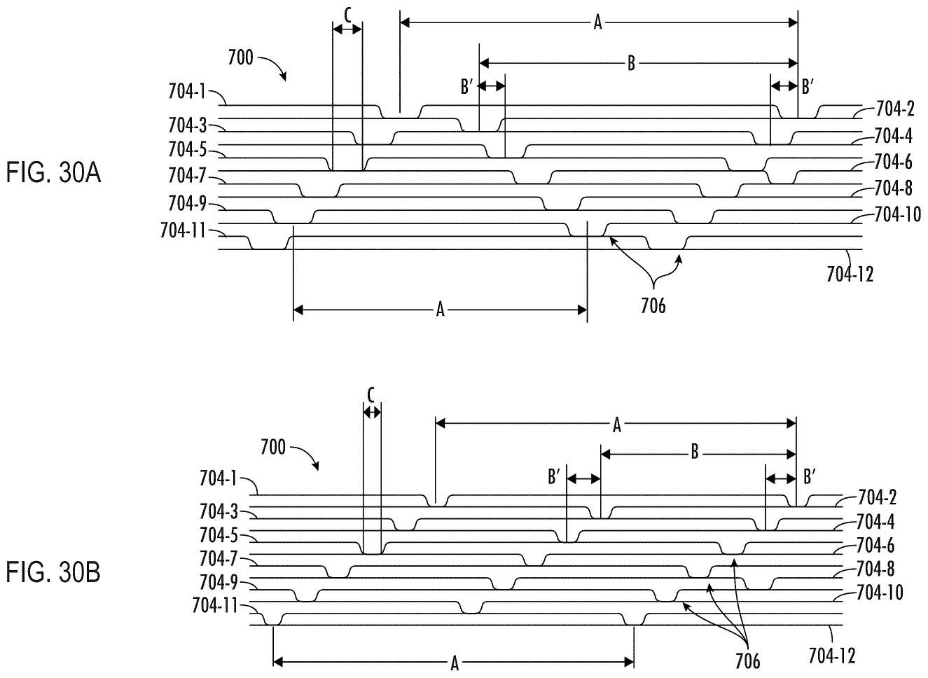

In further embodiments, the intermittent bonding pattern is a triangular or sawtooth bonding pattern. As shown in FIG. 30A, four parameters are used to define the triangular pattern. In such embodiments, the first parameter A still refers to the longitudinal distance between intermittent bonds 706 joining a particular pair of subunits 704. The second parameter B refers to the offset between an intermittent bond 706 at interface 704-1/704-2 and an intermittent bond 706 at interface 704-2/704-3. In embodiments, the second parameter B is from half the first parameter A to less than the first parameter A (i.e., 0.5A≤B<A). The third parameter C still refers to the length of the intermittent bond. The fourth parameter B′ refers to the distance between intermittent bonds 706 at successive odd interfaces (704-1/704-2, 704-3/704-4, . . . ) and at successive even interfaces (704-2/704-3, 704-4/704-5, . . . ). In embodiments, the sign of the fourth parameter B′ may be the same for the intermittent bonds 706 at the even interfaces and at the odd interfaces, and in other embodiments, the sign of the fourth parameter B′ may be different for the intermittent bonds 706 at the even interfaces and at the odd interfaces.

In embodiments of the triangular bonding pattern shown in FIG. 30A, the second parameter B is set at about A*((X−0.5)/X) in which X is the number of interfaces between subunits 704 of the optical fiber ribbon 700 or one less than the number of subunits 704. Further, in particular embodiments of the triangular bonding pattern, the fourth parameter B′ is equal to A/X. In the case of a twelve subunit 704 optical fiber ribbon 700, the second parameter B is equal to about 0.95A (i.e., A(11−0.5)/11), and the fourth parameter B′ is about 0.09A (i.e., A/11). Further, in the embodiment of FIG. 30A, the odd and even interfaces are offset in the opposite direction defining the triangular bonding pattern. That is, starting from the first odd interface 704-1/704-2, the subsequent odd interfaces (704-3/704-4, 704-5/704-6, . . . ) are offset to the left, whereas starting from the first even interface 704-2/704-3, the subsequent even interfaces (704-4/704-5, 704-6/704-7, . . . ) are offset to the right.

In the embodiment shown in FIG. 30B, a sawtooth bonding pattern is shown using the same four parameters as the triangular bonding pattern. In a particular embodiment of the sawtooth bonding pattern, the second parameter B is set at about A*((X/2+0.5)/X). The fourth parameter B′ is A/X. Besides the difference in the second parameter B, the sawtooth bonding pattern differs from the triangular bonding pattern in that the sign of the fourth parameter B′ is the same for the intermittent bonds 706 at the odd and even interfaces. That is, starting from the first odd interface 704-1/704-2, the subsequent odd interfaces (704-3/704-4, 704-5/704-6, . . . ) are offset to the left, and starting from the first even interface 704-2/704-3, the subsequent even interfaces (704-4/704-5, 704-6/704-7, . . . ) are also offset to the left. In both the triangular bonding pattern and the sawtooth bonding pattern, though, there is no overlap of the center of the intermittent bonds 706 across the width of the optical fiber ribbon 700.

Applicant found that the first parameter A had the greatest impact on the global and local out-of-plane deflection of the optical fibers in the ribbon 700. In particular, Applicant found that a spacing of 15 mm to 200 mm, in particular 30 mm to 150 mm, and most particularly 70 mm to 80 mm, provided a desirable balance between global and local out-of-plane deflection.

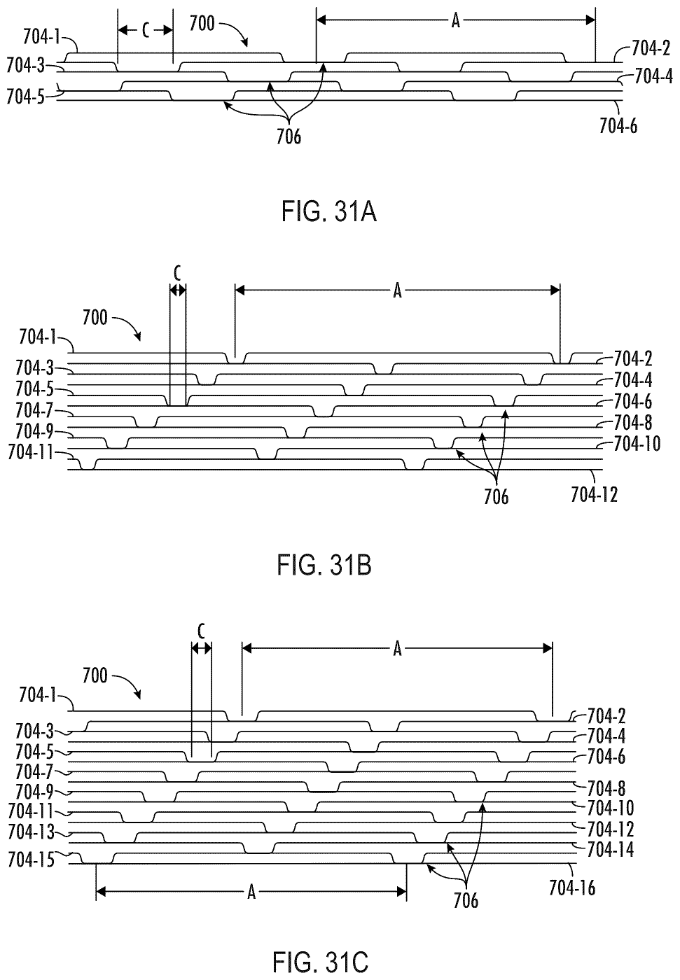

Optimal intermittent bond 706 lengths were also determined. FIG. 31A depicts an optical fiber ribbon 700 with six subunits 704 in the triangular or sawtooth pattern. Parameters A and C are depicted. As mentioned, parameter A is selected to be 15 mm to 200 mm. Parameter C, relating to the bond length, was determined to have a maximum dimension of 0.18A for the six subunit 704 embodiment. FIG. 31B depicts an optical fiber ribbon 700 with twelve subunits 704 having the triangular or sawtooth pattern. For this embodiment, parameter C was determined to have a maximum dimension of 0.091A. FIG. 31C depicts an optical fiber ribbon 700 with sixteen subunits 704 having the triangular or sawtooth pattern. For this embodiment, parameter C was determined to have a maximum dimension of 0.067A.

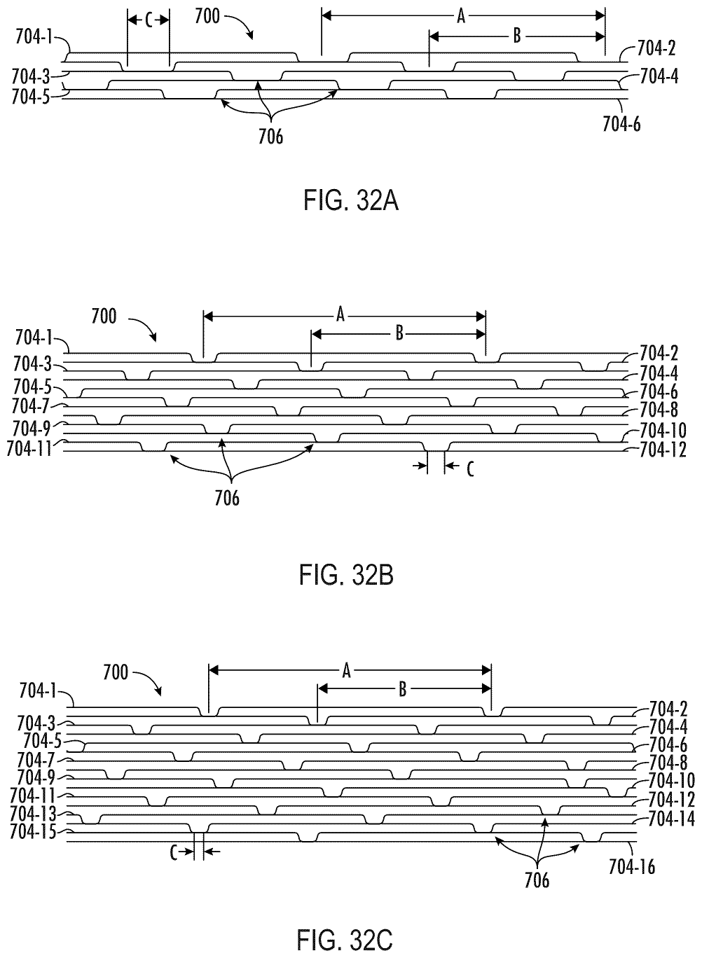

FIG. 32A depicts an optical fiber cable 10 with six subunits 704 having a bonding pattern based on an irrational number, in particular the golden ratio. Parameters A and C are depicted. As mentioned, parameter A is selected to be 15 mm to 200 mm. Parameter C, relating to the bond length, was determined to have a maximum dimension of 0.15A. FIG. 32B depicts an optical fiber cable 10 with twelve subunits 704 having a bonding pattern based on the golden ratio. Parameter C was determined to have a maximum dimension of 0.056A. FIG. 32C depicts an optical fiber ribbon 700 with sixteen subunits 704 having a bonding pattern based on the golden ratio. Parameter C was determined to have a maximum dimension of 0.034A.

Thus, using the intermittent bonding patterns described herein, overlap between intermittent bonds 706 of the subunits 704 across the width of the optical fiber ribbon 700 can be avoided, which improves flexibility and allows for the optical fiber ribbon to assume a compact cross-section for placement in an optical fiber cable.

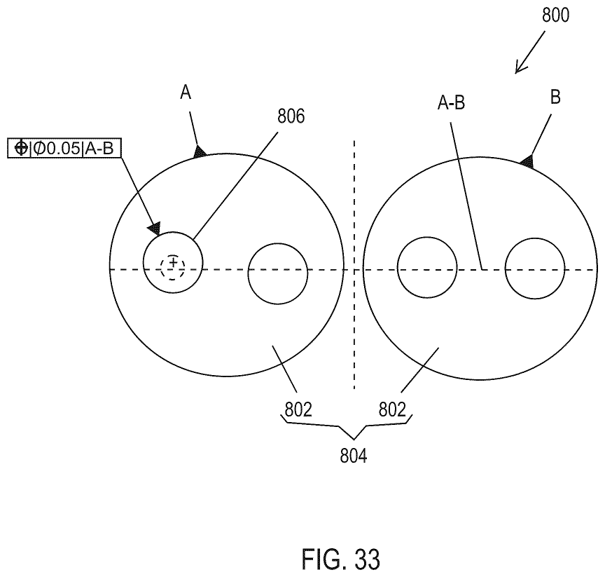

As shown in FIG. 33, the angular orientation of the optical fibers 802 (such as PM optical fibers 100 or multicore optical fibers 300) can be described relative to another optical fiber 802 in the subunit 804 or in the ribbon 800 using geometric dimensioning and tolerancing (GD&T), in particular according to ASME Y14.5-2009. For example, the side-imaging discussed above allows the optical fibers 802 to be put in proper angular orientation for joining into subunits 804 or into an optical fiber ribbon 800, and the GD&T true position (*) can be used to confirm the proper angular orientation of the optical fibers 802 at the endfaces of the optical fibers 802. That is, the optical fibers 802 will meet the tolerancing requirements described according to GD&T if the side-imaging properly aligns the optical fibers 802 when joining them.

With reference to FIG. 33, the proper tolerance of the optical fibers 802 is described by first selecting two adjacent optical fibers 802 as datum features (A, B) to create a reference for establishing the true position. In particular, FIG. 33 shows the outer surface of a cladding of the optical fibers 802 as the datum features. By using adjacent optical fibers 802 as datum features, a datum plane (A-B), having an origin between the optical fibers 802 is established between the optical fibers 802. The position of the centroid of a feature 806 can then be specified with the desired degree of tolerance relative to the datum plane (A-B). In one or more embodiments of a PM optical fiber 100, the feature 806 for which a tolerance is provided is a stress member 106. As shown in FIGS. 1A-1C, the stress member 106 can be a variety of shapes (e.g., cylindrical, trapezoidal, or elliptical), and calculation of the centroid for the stress member 106 shape can be done using known techniques, e.g., known equations for common shapes or known image analysis software for irregular shapes. In this way, the true position of the centroid can be specified for any feature shape, and the tolerance for the true position of the centroid relative to the datum plane can then be specified. For a multicore optical fiber 300, the feature 806 can be the marker 310.

FIG. 33 depicts two optical fibers 802 with features 806, which could be, e.g., a stress member 106 or a marker 310. The centroid (+) of one feature 806 is shown relative to the datum plane (A-B). In one or more embodiments, the dimensional tolerance of the centroid with respect to the datum plane is specified based on a circle (shown in dashed lines) having a diameter (ø) within which the centroid can acceptably be located. In one or more embodiments, the diametrical tolerance of a feature centroid of the optical fiber 802 is 50 μm (shown as 0.05 mm in FIG. 33). In other words, the centroid of the feature 806 can acceptably be located anywhere within the area defined by the tolerance circle having a diameter of 50 μm. Thus, as shown in FIG. 33, the angular alignment of the left optical fiber 802 does not exactly match the right optical fiber 802, but the mismatch is within an acceptable tolerance (e.g., within 50 μm). In other embodiments, the diametrical tolerance may be 50 μm or less, 40 μm or less, 30 μm or less, 20 μm or less, or 10 μm. Advantageously, when the optical fibers 802 are aligned prior to joining into subunits 804, the alignment of the subunits 804 for intermittent or continuous bonding as described above is made easier because the subunits 804 have asymmetry that allows for easier identification of the proper orientation of each subunit 804 to another subunit 804.

Various modifications and alterations may be made to the examples within the scope of the claims, and aspects of the different examples may be combined in different ways to achieve further examples. Accordingly, the true scope of the claims is to be understood from the entirety of the present disclosure in view of, but not limited to, the embodiments described herein.

It will be apparent to those skilled in the art that various modifications and variations can be made without departing from the spirit or scope of the claims.

What is claimed is:

1. An optical fiber ribbon, comprising:
a plurality of optical fibers arranged adjacently;
wherein the plurality of optical fibers are joined intermittently or continuously along their length;
wherein each optical fiber of the plurality of optical fibers comprises at least one core having a first refractive index, a cladding region having a second refractive index different from the first refractive index, and a third region disposed within the cladding region, the third region having a third refractive index different from the first refractive index and from the second refractive index; and
wherein the third region of each optical fiber comprises a centroid having a true position according to ASME Y14.5-2009 relative to an adjacent optical fiber that is within a diametrical tolerance of 50 μm.

2. The optical fiber ribbon of claim 1, wherein the third region is at least one stress member in which the third refractive index is less than the first refractive index and the second refractive index, the at least one stress member configured to create a fast axis and a slow axis in each optical fiber to maintain polarization of light in each of the at least one core.

3. The optical fiber ribbon of claim 2, wherein the at least one stress member comprises two stress members diametrically opposed on opposite sides of the at least one core.

4. The optical fiber ribbon of claim 3, wherein the two stress members comprise circular cross-sections.

5. The optical fiber ribbon of claim 3, wherein the two stress members comprise trapezoidal cross-sections.

6. The optical fiber ribbon of claim 2, wherein the at least one stress member comprises an elliptical cross section surrounding the at least one core in each of the plurality of optical fibers.

7. The optical fiber ribbon of claim 1, wherein the at least one core comprises at least two cores.

8. The optical fiber ribbon of claim 7, wherein the third region of each optical fiber of the plurality of optical fibers is a marker and wherein the third refractive index is less than the first refractive index and less than the second refractive index.

9. The optical fiber ribbon of claim 7, wherein the at least one core comprises four cores.

10. The optical fiber ribbon of claim 9, wherein the four cores are arranged in a 2×2 array.

11. The optical fiber ribbon of claim 9, wherein the four cores are arranged in a 1×4 array.

12. The optical fiber ribbon of claim 1, wherein, when imaged from along the length of the plurality of optical fibers, each cladding region has a characteristic width and wherein the characteristic width of each cladding region varies by 10% or less from an adjacent optical fiber.

13. A method of joining a plurality of optical fibers, comprising
determining an angular orientation of each optical fiber of the plurality of optical fibers, each optical fiber comprises at least one core, a cladding surrounding the at least one core, and a third region disposed within the cladding;
independently adjusting the angular orientation of each optical fiber of the plurality of optical fibers so that the third region of each optical fiber has substantially a same angular orientation as the third region of each other of the plurality of optical fibers;
intermittently or continuously bonding the plurality of optical fibers to each other while the third regions have the same angular orientation.

14. The method of claim 13, wherein the determining comprises:
capturing a side view of each optical fiber such that the at least one core, the cladding, and the third region appear as distinct strips in the side view; and
determining the angular orientation of each optical fiber based on a measurement of a characteristic width of one or more of the distinct strips relative to a desired characteristic width for a particular angular orientation.

15. The method of claim 14, wherein the at least one core comprises a plurality of cores contained within the cladding, wherein the third region comprises a marker, wherein determining further comprises rotating each optical fiber until the marker creates a distinct strip in the side view so that a position of the marker is determined, and wherein independently adjusting further comprises further rotating or counterrotating the optical fiber in view of the determined position of the marker and until the desired characteristic width is achieved.

16. The method of claim 13, wherein intermittently or continuously bonding comprises continuously bonding the plurality of optical fibers into a plurality of subunits of at least two optical fibers.

17. A system for joining a plurality of optical fibers, comprising:
an imaging system configured to capture a side view of each optical fiber of the plurality of optical fibers;
an applicator configured to deposit bonding material continuously around or intermittently between adjacent optical fibers of the plurality of optical fibers; and
a control system configured to determine an angular orientation of each optical fiber of the plurality of optical fibers based on a characteristic width of a component of each optical from the side view of each optical fiber;
wherein the control system is further configured to independently adjust the angular orientation of each optical fiber based on the determined angular orientation.

18. The system of claim 17, wherein the image system comprises a camera and a light and wherein the light is positioned to illuminate the plurality of optical fibers from an opposite side of the plurality of optical fibers from the camera.

19. The system of claim 17, further comprising a UV light source configured to cure the bonding material.

20. The system of claim 19, wherein the imaging system, the applicator, and the UV light source are contained within a chamber and wherein the chamber is configured to be purged with nitrogen in order to control exposure of the bonding material to oxygen.
